(19) United States
(12) Patent Application Publication
(10) Pub. No.: US 2026/0036921 A1
(43) Pub. Date: Feb. 5, 2026

(54) TONER

(71) Applicant: CANON KABUSHIKI KAISHA, Tokyo (JP)

(72) Inventors: HIROKI KAGAWA, Shizuoka (JP); YUU SASANO, Shizuoka (JP); TOHRU HIRAMATSU, Shizuoka (JP); SHOHEI SHIBAHARA, Shizuoka (JP)

(21) Appl. No.: 19/277,626

(22) Filed: Jul. 23, 2025

(30) Foreign Application Priority Data
Jul. 30, 2024 (JP) 2024-123239
Jul. 1, 2025 (JP) 2025-111546

(51) Int. Cl. G03G 9/097; G03G 9/08; G03G 9/093

(52) U.S. Cl. CPC G03G 9/09758; G03G 9/0819; G03G 9/09328; G03G 9/09378

(57) ABSTRACT

A toner including: a toner particle containing a binder resin; and an inorganic fine particle, wherein the inorganic fine particle contains a strontium titanate fine particle A, a silica fine particle B, and a hydrotalcite particle C, Si is present at a surface of the strontium titanate fine particle A, and a value Si/Sr of a mass ratio of Si to Sr, which is detected in a fluorescent X-ray analysis of the strontium titanate fine particle A, satisfies the following formula (1); 0.20≤Si/Sr≤0.60 . . . (1).

### BACKGROUND

### Field of the Technology

The present disclosure relates to a toner that is used in a copier and a printer in which an electrophotographic method or an electrostatic recording method is used.

### Description of the Related Art

In recent years, for image forming devices, such as copiers or printers, diversification of intended uses and usage environments has been underway, and there has been a demand for stable image quality being achieved in all environments.

In order to achieve stable image quality, for example, Japanese Patent Application Laid-open No. 2018-194837 discloses that the chargeability of a toner is improved by disposing an external additive having both (positive and negative) polarities, such as a hydrotalcite particle (hereinafter also referred to as “hydrotalcite”), at the surface.

The hydrotalcite particle is charged to a polarity opposite to that of the toner, is likely to act as a carrier, and improves the chargeability of the toner. When the hydrotalcite is combined with a material that imparts high fluidity to the toner, such as a silica fine particle, it is possible to provide a toner having excellent charge build-up properties and to achieve a stable image quality even in an environment where chargeability is likely to deteriorate, such as a high-temperature and high-humidity environment.

In order to enhance the function of the hydrotalcite as a carrier, the hydrotalcite needs to be in a state of a high degree of freedom at the surface of the toner; however, when the hydrotalcite is disposed with a high degree of freedom, a phenomenon of the hydrotalcite being concentrated often occurs particularly during long-term use. In addition, when the hydrotalcite and the silica fine particle are jointly used, the highly adhesive silica fine particle adheres to the surface of the hydrotalcite, and an aggregated mass of the hydrotalcite through the silica fine particle is likely to be generated, and the concentration of the hydrotalcite thus becomes significant.

When the concentration of the hydrotalcite occurs particularly in an environment where chargeability is likely to improve, such as a low-temperature and low-humidity environment, chargeability becomes excessive, and various image harmful effects, such as ghost, thus occurs at the end of durable use. In order to prevent this phenomenon, enhancement of the adhesion of the hydrotalcite to the surface of the toner particle can be considered, but the function of the hydrotalcite as a carrier deteriorates, and the advantage of using the hydrotalcite reduces. Furthermore, in a case where the hydrotalcite and the silica fine particle are jointly used, a problem including member contamination attributed to the above-described aggregated mass is likely to occur.

As described above, in a system where the hydrotalcite particle and the silica fine particle are used, it has not yet been possible to embody a toner enabling a stable image quality to be obtained in all environments.

### SUMMARY

Therefore, the present disclosure provides a toner that has charge build-up properties in a high-temperature and high-humidity environment and charge stability in a low-temperature and low-humidity environment and enables an excellent image quality to be obtained while the toner contains a hydrotalcite particle and a silica fine particle.

The present disclosure relates to a toner comprising: a toner particle containing a binder resin; and an inorganic fine particle, wherein the inorganic fine particle contains a strontium titanate fine particle A, a silica fine particle B, and a hydrotalcite particle C, Si is present at a surface of the strontium titanate fine particle A, and a value Si/Sr of a mass ratio of Si to Sr, which is detected in a fluorescent X-ray analysis of the strontium titanate fine particle A, satisfies the following formula (1); 0.20≤Si/Sr≤0.60 . . . (1).

Features of the present disclosure will become apparent from the following description of embodiments with reference to the attached drawings. The following description of embodiments is described by way of example.

### BRIEF DESCRIPTION OF THE DRAWINGS

FIG. 1 shows an image used for ghost evaluation.

FIGS. 2A and 2B are schematic views of a measuring instrument of a powder specific resistance value.

### DESCRIPTION OF THE EMBODIMENTS

Unless otherwise specified, descriptions of numerical ranges such as “from XX to YY” or “XX to YY” in the present disclosure include the numbers at the upper and lower limits of the range. When numerical ranges are described in stages, the upper and lower limits of each of each numerical range may be combined arbitrarily. In the present disclosure, wording such as “at least one selected from the group consisting of XX, YY and ZZ” means any of: XX; YY; ZZ; a combination of XX and YY; a combination of XX and ZZ; a combination of YY and ZZ; or a combination of XX and YY and ZZ.

In the present disclosure, “monomer unit” refers to a reacted form of a monomer substance in the polymer. For example, in the amorphous polyester resin, a monomer substance between ester bonds is defined as one unit. In addition, in mol % calculations, the one unit corresponds to one molecule.

The fact that a monomer unit is derived from a certain monomer substance can be confirmed from the fact that the structure of the monomer unit corresponds to the reacted structure of the certain monomer substance.

In a system where a hydrotalcite particle and a silica fine particle are jointly used as described above, the concentration of the hydrotalcite is likely to occur, and overcharge in a low-temperature and low-humidity environment becomes a problem. In order to suppress excessive chargeability, there is a method of incorporating a low-resistance material, such as a strontium titanate fine particle, into a toner, but a normal strontium titanate fine particle is likely to be charged to a polarity opposite to that of a silica fine particle and electrostatically attracts the silica fine particle. Therefore, the generation of the above-described aggregated mass of the hydrotalcite through the silica fine particle is promoted, and the concentration of the hydrotalcite cannot be improved.

As a result of intensive studies, the present inventors found that the control of the ratio between Si and Sr by incorporating Si into the surface of the strontium titanate fine particle is effective for suppression of the generation of an aggregated mass and the concentration of the hydrotalcite.

That is, the present disclosure relates to a toner comprising: a toner particle containing a binder resin; and an inorganic fine particle, wherein the inorganic fine particle contains a strontium titanate fine particle A, a silica fine particle B, and a hydrotalcite particle C, Si is present at a surface of the strontium titanate fine particle A, and a value Si/Sr of a mass ratio of Si to Sr, which is detected in a fluorescent X-ray analysis of the strontium titanate fine particle A, satisfies the following formula (1);

$$0.2 \leq Si / Sr \leq 0 \text{.60} . \qquad ( 1 )$$

The reason for the above-described configuration being effective will be described.

When the surface of the strontium titanate fine particle contains Si to an extent that the above formula (1) is satisfied, the strontium titanate fine particle becomes closer to silica fine particle in terms of the triboelectric series while low resistance is maintained. Therefore, the strontium titanate fine particle is likely to be charged to the same polarity as the silica fine particle and electrostatically repulses the silica fine particle, and the generation of an aggregated mass of the hydrotalcite through the silica fine particle is suppressed. As a result, the concentration of the hydrotalcite is improved, and it is possible to sufficiently obtain an effect of the hydrotalcite improving the charge build-up properties in a high-temperature and high-humidity environment. In addition, in combination with an effect of the strontium titanate fine particle as a low-resistance material, overcharge in a low-temperature and low-humidity environment is suppressed. Also, a problem of member contamination attributed to the aggregated mass is also improved.

Therefore, it is possible to obtain a toner that has charge build-up properties in a high-temperature and high-humidity environment and charge stability in a low-temperature and low-humidity environment and enables an excellent image quality to be obtained.

Hereinafter, the toner will be described in more detail.

A toner of the present disclosure contains a toner particle containing a binder resin and an inorganic fine particle. The inorganic fine particle contains a strontium titanate fine particle A, and the strontium titanate fine particle A contains Si present at the surface. The details of a method for confirming the presence of Si at the surface of the strontium titanate fine particle A will be described below, and the presence of Si can be confirmed by SEM-EDS measurement. In a case where Si is not present at the surface of the strontium titanate fine particle A, the effect of the present disclosure cannot be obtained.

The value (Si/Sr) of the mass ratio of Si to Sr, which is detected in the fluorescent X-ray analysis of the strontium titanate fine particle A, satisfies the following formula (1).

$$0.2 \leq Si / Sr \leq 0.6 \qquad ( 1 )$$

When (Si/Sr) is 0.20 or more, electrostatic repulsion between the silica fine particle and the strontium titanate fine particle A sufficiently occurs, and an effect of suppressing the concentration of hydrotalcite can be obtained. On the other hand, when the (Si/Sr) is 0.60 or less, the resistance of the strontium titanate fine particle A is appropriately kept.

In addition, the toner contains a silica fine particle B and a hydrotalcite particle C. A strontium titanate fine particle A, a silica fine particle B, and a hydrotalcite particle C must all be contained to achieve the aforementioned effect.

Hereinafter, a preferable embodiment of the present disclosure will be described.

A content M_{A} of the strontium titanate fine particle is, for example, 0.05 to 2.5 parts by mass, preferably 0.1 to 1.5 parts by mass, more preferably 0.3 to 1.5 parts by mass, and still more preferably 0.5 to 1.5 parts by mass with respect to 100 parts by mass of the toner particle. When the content is 0.1 part by mass or more, an overcharge suppressing effect is sufficiently large, and when the content is 1.5 parts by mass or less, the chargeability of the toner becomes sufficiently large. The strontium titanate fine particle of the present disclosure is a fine particle including Si present at the surface thereof.

The number average particle size of the strontium titanate fine particle A is, for example, 10 to 120 nm and preferably 25 to 80 nm. When the number average particle size is 25 nm or more, overcharge is less likely to occur, and the charge distribution is likely to become sharp. In addition, when the number average particle size is 80 nm or less, the charge build-up of the toner becomes faster.

A content of the silica fine particle B is preferably 0.1 to 1.5 parts by mass, more preferably 0.4 to 1.4 parts by mass, and still more preferably 0.4 to 1.0 part by mass with respect to 100 parts by mass of the toner particle. When the content is within the above range, the fluidity and charge build-up properties of the toner become more favorable.

The number average particle size of the silica fine particle B is, for example, 5 to 80 nm, preferably 5 to 50 nm, and more preferably 6 to 30 nm. When the particle size is within the above range, the fluidity and charge build-up properties of the toner become more favorable.

A content M_{C} of the hydrotalcite particle C is, for example, 0.04 to 1.20 parts by mass and preferably 0.05 to 1.00 part by mass with respect to 100 parts by mass of the toner particle. When the content is within the above range, the charge build-up properties and charge stability of the toner, and the scratch resistance of a fixed image become more favorable.

The number average particle size of the hydrotalcite particle C is, for example, 30 to 700 nm and preferably 60 to 500 nm. When the particle size is within the above range, the charge build-up properties and charge stability of the toner become more favorable.

A powder specific resistance value R_{A} of the strontium titanate fine particle A is, for example, 7.0×10⁷ to 7.0×10¹² (2 cm, preferably 1.0×10⁸ to 1.0×10¹² Ω·cm, and more preferably 1.0×10⁹ to 1.0×10¹² Ω·cm. When the R_{A} is 1.0×10⁸ Ω·cm or more, the charge build-up properties become more favorable, and when the R_{A} is 1.0×10¹² Ω·cm or less, the overcharge suppressing effect becomes more sufficient.

The powder specific resistance value R_{A} of the strontium titanate fine particle A can be controlled by the particle size of the strontium titanate fine particle, the amount of Si, such as a silica-containing particle source, added during the production, and the type and content of a surface treatment agent.

When the powder specific resistance value of the strontium titanate fine particle A is indicated by R_{A}, the R_{A} and a value (Si/Sr) of the mass ratio preferably satisfy the following formula (4). R_{A}/(Si/Sr) is more preferably 1.0×10⁹ to 2.0×10¹¹.

$$1.7 \times 1 {0}^{8} \leq {R}_{A} / ( Si / Sr ) \leq 3. \times 1 {0}^{12} \qquad ( 4 )$$

When the formula (4) is satisfied, the charge build-up properties and the charge stability become more favorable.

When the content of the strontium titanate fine particle A with respect to 100 parts by mass of the toner particle is indicated by M_{A}, and the content of the hydrotalcite particle C with respect to 100 parts by mass of the toner particle is indicated by M_{C}, a value M_{A}/M_{C} of the ratio of M_{A} to M_{C} is, for example, 0.20 to 25.0. The M_{A}/M_{C} preferably satisfies the following formula (2).

$$0.3 \leq {M}_{A} / {M}_{C} \leq 20.0 \qquad ( 2 )$$

When the formula (2) is satisfied, the charge build-up properties and the charge stability become more favorable.

The value (Si/Sr) of the mass ratio of Si to Sr, which is detected in the fluorescent X-ray analysis of the strontium titanate fine particle A, preferably satisfies the following formula (3).

$$0.26 \leq Si / Sr \leq 0.50 \qquad ( 3 )$$

When the formula (3) is satisfied, the charge build-up properties and the charge stability become particularly favorable. The Si/Sr can be controlled by the amount of Si, such as the silica-containing particle source, added during the production of the strontium titanate fine particle and the type and content of a surface treatment agent including Si.

A Si-containing protrusion portion is preferably present at the surface of the strontium titanate fine particle A. The presence of the Si-containing protrusion portion at the surface of the strontium titanate fine particle A makes it easy for an electrostatic repulsion effect with the silica fine particle to work, also reduces the adhesion of the strontium titanate fine particle itself, and makes the effect of the hydrotalcite suppressing an aggregated mass larger.

In addition, the protrusion portion is preferably formed of a silica fine particle. Examples of the protrusion portion include a protrusion portion formed by embedding a silica fine particle therein and a protrusion portion formed by making a silica fine particle adhere thereto. The same effect is exhibited in both the protrusion portion formed by embedding a silica fine particle therein and the protrusion portion formed by making a silica fine particle adhere thereto instead of embedding. The silica fine particle forming the protrusion portion is, for example, a silica fine particle other than the silica fine particle B.

The Si-containing protrusion portion can be formed by adding a silica-containing particle source at the time of producing the strontium titanate fine particle A. The Si-containing protrusion portion will be specifically described below. The number average particle size of the particle in the protrusion portion is preferably less than 5 nm from the viewpoint of charge build-up properties. The number average particle size of the particle in the protrusion portion is preferably at least 1 nm and less than 5 nm.

The Bragg angle of the strontium titanate fine particle A is indicated by Θ. At this time, the strontium titanate fine particle preferably has peaks in ranges of 39.700°±0.150° and 46.200°±0.150°, respectively, in a CuKα X-ray diffraction spectrum that is obtained in a 2Θ range of 10° to 90°. In addition, when the area of the peak at 39.700°±0.150° is indicated by Sa, and the area of the peak at 46.200°±0.150° is indicated by Sb, the Sb/Sa is preferably 1.80 to 2.30 and more preferably 1.90 to 2.10.

Strontium titanate having peaks at these positions has a perovskite structure belonging to the cubic system, and peaks in the ranges of 39.700°±0.150° and 46.200°±0.150° are diffraction peaks derived from lattice planes of Miller indices (111) and (200), respectively.

Generally, a particle belonging to the cubic system is likely to have a hexahedral shape as the appearance shape of the particle, and the strontium titanate fine particle also grows while having a (100) plane and a (200) plane that correspond to the plane directions of the hexahedral shape in a production process. In the case of using the strontium titanate fine particle having a (200) plane corresponding to the plane direction of the hexahedral shape and a (111) plane corresponding to the apical direction in an appropriate ratio, it is possible to further suppress member contamination.

The toner particle preferably contains ester wax. When the toner particle contains an ester wax, the low-temperature fixability improves. In addition, the scratch resistance of a fixed image improves. As a mechanism for improving the scratch resistance, the following is expected.

The hydrotalcite present at the surface of a fixed image has a relatively large particle size and is thus likely to detach when the surface of the fixed image is rubbed. When the toner particle contains the ester wax, an ester group of the ester wax and a hydroxyl group at the surface of the hydrotalcite are hydrogen-bonded, and the detachment of the hydrotalcite from the surface of the fixed image is thus suppressed. As a result, the scratch resistance improves.

The ester wax is preferably a polyfunctional ester wax having two or more ester groups. When the ester wax has a plurality of ester groups, the compatibility with a binder resin improves, and the low-temperature fixability further improves.

The ester wax is preferably a bifunctional ester wax having two ester groups. When the ester wax has two ester groups, the balance between the above-described effect of suppressing the detachment of the hydrotalcite and an increase of a frictional force due to an increase of moisture adsorption attributed to the plurality of ester groups becomes optimum, and the scratch resistance further improves.

Each component constituting the toner and a method for producing the toner will be described in more detail.

### Strontium Titanate Fine Particle A

The strontium titanate fine particle A can be produced by, for example, a normal pressure heating reaction method. At this time, a mineral acid peptized product of a hydrolysate of a titanium compound can be used as a titanium oxide source, and a water-soluble acidic strontium source compound can be used as a strontium source.

In a method for forming the Si-containing protrusion portion at the surface of the strontium titanate fine particle, a mineral acid peptized product of a hydrolysate of a titanium compound, a strontium source, and a silica-containing particle source are mixed together. In addition, the raw materials are reacted together while an alkaline aqueous solution is added to a mixed liquid of the raw materials at 60° C. to 100° C., and an acid treatment is then performed. The protrusion portion can be produced by such a method.

Hereinafter, the normal pressure heating reaction method will be described.

As the titanium oxide source, a mineral acid peptized product of a hydrolysate of a titanium compound is used. It is preferable to use a peptized product of metatitanic acid having a SO₃ content of 1.0 mass % or less, more preferably 0.5 mass % or less, obtained by a sulfuric acid method obtained by adjusting the pH with hydrochloric acid to 0.8 to 1.5.

Incidentally, as the strontium source, a nitrate, hydrochloride, or the like of strontium can be used.

As the nitrate, for example, strontium nitrate can be used. As the hydrochloride, for example, strontium chloride can be used. The strontium titanate fine particle obtained here has a perovskite crystal structure, and the environmental stability of charging thus further improves, which is preferable.

Subsequently, the shape control will be described. In order to obtain the above-described shape of the strontium titanate fine particle, a dry mechanical treatment may be performed as an example.

For example, a hybridizer (manufactured by Nara Machinery), NOBILTA (manufactured by Hosokawa Micron Corporation), MECHANO FUSION (manufactured by Hosokawa Micron Corporation), HIGH FLEX GRAL (manufactured by EARTHTECHNICA Co., Ltd.), and the like can be used. When the strontium titanate fine particle is treated with these devices, it is easy to control the Sb/Sa to be from 1.80 to 2.30.

In the case of controlling the shape of the strontium titanate fine particle by the mechanical treatment, a fine powder of the strontium titanate fine particle may be generated. In order to remove the fine powder, an acid treatment is preferably performed after the mechanical treatment. In the acid treatment, the pH is preferably adjusted to 0.1 to 5.0 using hydrochloric acid. As the acid, aside from hydrochloric acid, nitric acid, acetic acid and the like can be used in the acid treatment. The mechanical treatment for controlling the shape of the strontium titanate fine particle is preferably performed before the surface treatment of the strontium titanate fine particle is performed.

Examples of the silica-containing particle source include sodium silicate, silica, and the like. The addition of the silica-containing particle source makes it possible to form the Si-containing protrusion portion.

The amount of the silica-containing particle source added is a factor that affects the Si-containing protrusion portion present at the surface of the strontium titanate fine particle and can be appropriately adjusted to obtain a target particle size and a target particle shape.

As the alkaline aqueous solution, a caustic alkali can be used, and a sodium hydroxide aqueous solution is particularly preferable.

Examples of the factors that affect the particle size of the strontium titanate fine particle to be obtained and the Si-containing protrusion portion present at the surface of the strontium titanate fine particle in the production method include the following.

The pH at the time of the peptization of the metatitanic acid with hydrochloric acid, the mixing percentages of the titanium oxide source, the strontium source, and the silica-containing particle source, the concentration of the titanium oxide source and the concentration of the silica-containing particle source in the initial stage of the reaction, the temperature and addition rate at the time of adding the alkaline aqueous solution, the reaction time, the stirring conditions, and the like.

In addition, in a step of adding the alkaline aqueous solution, the half-value width of the strontium titanate fine particle can be controlled by adding the alkaline aqueous solution while ultrasonic vibration is applied thereto. The application of the ultrasonic vibration in a reaction step makes the precipitation rate of crystals fast and makes it possible to obtain a particle having a small crystallite diameter. It is preferable to rapidly cool an aqueous solution for which the reaction has been ended by the addition of the alkaline aqueous solution in terms of controlling the half-value width.

Examples of a method for the rapid cooling include a method in which pure water cooled to 10° C. or lower is added until the aqueous solution reaches a desired temperature. The rapid cooling makes it possible to suppress an increase in the crystallite diameter in the cooling step.

In addition, when the reaction is stopped by injecting a system into ice water or the like to rapidly decrease the temperature of the system after the addition of the alkaline aqueous solution, it is possible to forcibly stop the reaction in the middle of saturation of the crystal growth and to control the particle size distribution.

Furthermore, the particle size distribution can be controlled by putting the reaction system into an uneven state by reducing the stirring rate, changing the stirring method, or the like. These factors can be adjusted as appropriate to obtain the strontium titanate fine particle having desired particle size and particle size distribution and the Si-containing protrusion portion.

It is preferable to prevent the incorporation of carbon dioxide by causing the reaction in a nitrogen gas atmosphere to prevent the generation of carbonate in a reaction process.

The mixing percentages of the titanium oxide source and the strontium source at the time of the reaction is preferably from 0.90 to 1.40 and more preferably from 1.05 to 1.20 in terms of the molar ratio of SrO/TiO₂ when strontium is indicated by Sr and an oxide thereof is indicated by SrO.

In a case where the SrO/TiO₂ (molar ratio) is 1.00 or less, not only metal titanate but also unreacted titanium oxide are likely to remain in a reaction product. Since the titanium oxide source has relatively low solubility in water compared with strontium having high solubility in water, in a case where the SrO/TiO₂ (molar ratio) is 1.00 or less, there is a tendency that not only metal titanate but also unreacted titanium oxide are likely to remain in the reaction product.

The concentration of the titanium oxide source at the initial stage of the reaction is preferably from 0.050 mol/L to 1.300 mol/L and more preferably from 0.080 mol/L to 1.200 mol/L in terms of TiO₂. When the concentration of the titanium oxide source in the initial stage of the reaction is increased, it is possible to decrease the number average particle size of the primary particle of the strontium titanate fine particle.

Practically, the temperature at the time of adding the alkaline aqueous solution is preferably in a range of 60° C. to 100° C. since a pressure vessel such as an autoclave is required when the temperature is 100° C. or higher.

In addition, regarding the addition rate of the alkaline aqueous solution, as the addition rate becomes slower, the strontium titanate fine particle having a larger particle size and the larger protrusion portion containing Si can be obtained. On the other hand, as the addition rate becomes faster, the strontium titanate fine particle having a smaller particle size and the smaller protrusion portion containing Si can be obtained.

The addition rate of the alkaline aqueous solution is preferably from 0.001 equivalent/h to 1.2 equivalents/h and more preferably from 0.002 equivalents/h to 1.1 equivalents/h relative to the charged raw materials. These can be adjusted as appropriate depending on a particle size desired to be obtained.

In the production method, it is preferable to further perform an acid treatment on the strontium titanate fine particle obtained by the normal pressure heating reaction. At the time of producing the strontium titanate fine particle by performing a normal pressure heating reaction, in a case where the mixing percentages of the titanium oxide source and the strontium source is greater than 1.00 in terms of the SrO/TiO₂ (molar ratio), the unreacted strontium remaining after the end of the reaction may react with carbon dioxide in the air to generate an impurity such as carbonate. In order to make it easy to uniformly apply a surface treatment agent, it is preferable to perform the acid treatment to remove an unreacted metal source after the addition of the aqueous alkali solution.

In the acid treatment, the pH is preferably adjusted to 2.5 to 7.0 and more preferably adjusted to 4.5 to 6.0 using hydrochloric acid.

As the acid, aside from hydrochloric acid, nitric acid, acetic acid and the like can be used in the acid treatment. When sulfuric acid is used, a metal sulfate having a low solubility in water is likely to be generated.

The shape of the strontium titanate fine particle may be controlled. The strontium titanate fine particle preferably has a cubic shape or a rectangular shape. In addition, as a method for controlling the shape of the strontium titanate fine particle, a method of performing a dry mechanical treatment may be used.

The strontium titanate fine particle may be surface-treated. A surface treatment agent is not particularly limited, and examples thereof include disilylamine compounds, halogenated silane compounds, silicone compounds, or silane coupling agents.

The value (Si/Sr) of the ratio can be controlled with the surface treatment agent.

The disilylamine compound is a compound having a disilylamine (Si—N—Si) site. Examples of the disilylamine compounds include hexamethyldisilazanes (HMDS), N-methyl-hexamethyldisilazanes, or hexamethyl-N-propyldisilazanes. Examples of the halogenated silane compounds include dimethyldichlorosilane.

Examples of the silicone compounds include silicone oils or silicone resins (varnishes). Examples of the silicone oils include dimethyl silicone oils, methyl phenyl silicone oils, α-methyl styrene-modified silicone oils, chlorophenyl silicone oils, or fluorine-modified silicone oils. Examples of the silicone resins (varnishes) include methyl silicone varnishes and phenylmethyl silicone varnishes.

Examples of silane coupling agents include silane coupling agents having an alkyl group and an alkoxy group, silane coupling agents having an amino group and an alkoxy group, or fluorine-containing silane coupling agents.

More specific examples of the silane coupling agents include dimethyldimethoxysilane, dimethyldiethoxysilane, diethyldimethoxysilane, diethyldiethoxysilane, trimethylmethoxysilane, trimethyldiethoxysilane, triethylmethoxysilane, triethyldiethoxysilane, propyltrimethoxysilane, propyltriethoxysilane, isobutyltrimethoxysilane, octyltrimethoxysilane, octyltriethoxysilane, γ-glycidoxypropyltrimethoxysilane, γ-chloropropyltrimethoxysilane, γ-aminopropyltriethoxysilane, γ-aminopropyltrimethoxysilane, γ-aminopropyldimethoxylmethylsilane, or γ-aminopropyldiethoxymethylsilane, 3,3,3-trifluoropropyldimethoxysilane, 3,3,3-trifluoropropyldiethoxysilane, perfluorooctylethyltriethoxysilane, 1,1,1-trifluorohexyldiethoxysilane, and the like.

The silane coupling agent is preferably a silane coupling agent having an alkyl group and an alkoxy group such as dimethyldimethoxysilane, dimethyldiethoxysilane, diethyldimethoxysilane, diethyldiethoxysilane, trimethylmethoxysilane, trimethyldiethoxysilane, triethylmethoxysilane, triethyldiethoxysilane, propyltrimethoxysilane, propyltriethoxysilane, isobutyltrimethoxysilane, octyltrimethoxysilane, or octyltriethoxysilane.

Among the silane coupling agents described above, silane coupling agents in which an alkyl group has 4 or less carbon atoms are preferable from the viewpoint of chargeability, and silane coupling agents treated with isobutyltrimethoxysilane are more preferable.

In addition, a preferable amount of the treatment agent used to treat the strontium titanate fine particle is an amount of 0.5 to 25.0 parts by mass relative to 100 parts by mass of the strontium titanate fine particle. The surface treatment agents may be used singly or two or more thereof may be used in combination.

The amount of C (carbon amount) derived from a hydrophobic treatment agent for the strontium titanate fine particle A is, for example, 0.5 to 10.0 mass % and preferably 0.8 to 5.0 mass %. When the amount of C is within the above range, the charge build-up properties and the charge stability become more favorable.

### Silica Fine Particle B

As the silica fine particle B, for example, the following silica can be used. Examples thereof include silica such as wet process silica and dry process silica, treated silica obtained by treating the surface of the above-described silica with a silane compound or silicone oil, and the like.

The silica fine particle B is more preferably a treated silica fine particle obtained by performing a hydrophobic treatment on a silica fine particle with silicone oil having a dimethylsiloxane structure.

When the SP value of the silicone oil having a dimethylsiloxane structure is indicated by SP_{D} (J/cm³)^{1/2}, and the SP value of the surface treatment agent for the strontium titanate fine particle A is indicated by SP_{A} (J/cm³)^{1/2}, the absolute value of SP_{A}−SP_{D} is preferably 3.50 or less. When the absolute value of the SP_{A}−SP_{D} is 3.50 or less, the polarities of the strontium titanate fine particle A and the silica fine particle B become close to each other, and the electrostatic repulsion effect becomes easier to work, which is preferable.

Here, the SP value of the silicone oil having a dimethylsiloxane structure refers to the SP value of the dimethylsiloxane structure, and the SP value of the surface treatment agent for the strontium titanate fine particle A refers to the SP value of the surface treatment agent in a form after a reaction with the strontium titanate fine particle. A method for calculating the SP value will be described below.

The silica fine particle B preferably has a specific surface area by nitrogen adsorption measured by a BET method of 30 m²/g to 300 m²/g.

### Hydrotalcite Particle C

The hydrotalcite particle C may be, for example, a general hydrotalcite particle represented by the following structural formula (A).

$${M}_{y}^{2 +} {{M}_{x}^{3 +} ( OH )}_{2} {A}^{n -} ( x / n ) \cdot m {H}_{2} O \qquad ( A )$$

Here, 0<x≤0.5, y=1−x, and m≥0.

M²⁺ and M³⁺ represent divalent and trivalent metals, respectively.

M²⁺ is preferably at least one divalent metal ion selected from the group consisting of Mg, Zn, Ca, Ba, Ni, Sr, Cu, and Fe. M³⁺ is preferably at least one trivalent metal ion selected from the group consisting of Al, B, Ga, Fe, Co, and In.

Aⁿ⁻ is an n-valent anion, examples thereof include CO₃²⁻, OH⁻, Cl⁻, I⁻, F⁻, Br⁻, SO₄²⁻, HCO₃⁻, CH₃COO⁻, and NO₃⁻, and one or a plurality of Aⁿ⁻'s may be present.

The hydrotalcite particle C preferably contains at least Al as M³⁺. In addition, the hydrotalcite particle C preferably contains at least Mg as M²⁺. The hydrotalcite particle C more preferably contains Al and Mg.

The hydrotalcite particle may be a solid solution containing a plurality of different elements. In addition, the hydrotalcite particle may contain a trace amount of a monovalent metal.

### Other External Additives

Specific examples of other external additives include an inorganic fine particle of titanium oxide or the like and a resin fine particle of a vinyl-based resin, a polyester resin, a silicone resin or the like. These external additives are preferably added by, for example, applying a shear force to the external additives in a dry state.

### Binder Resin

The toner particle contains a binder resin. The content of the binder resin is preferably 50 mass % or more of the total amount of the resin components in the toner particle.

The binder resin is not particularly limited, and examples thereof include a styrene acrylic resin, an epoxy resin, a polyester resin, a polyurethane resin, a polyamide resin, a cellulose resin, a polyether resin, a mixed resin or a composite resin thereof, and the like. The binder resin preferably contains at least one selected from the group consisting of a styrene acrylic resin and a polyester resin. The binder resin more preferably contains a styrene acrylic resin.

Examples of the styrene acrylic resin include homopolymers composed of the following polymerizable monomers, copolymers obtained by combining two or more thereof, and furthermore mixtures thereof.

Styrene-based monomers such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene;
(meth)acrylic monomers such as methyl (meth)acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, n-amyl (meth)acrylate, n-hexyl (meth)acrylate, 2-ethylhexyl (meth)acrylate, n-octyl (meth)acrylate, n-nonyl (meth)acrylate, cyclohexyl (meth)acrylate, benzyl (meth)acrylate, dimethyl phosphate ethyl (meth)acrylate, diethyl phosphate ethyl (meth)acrylate, dibutyl phosphate ethyl (meth)acrylate, and 2-benzoyloxy ethyl (meth)acrylate, (meth)acrylonitrile, 2-hydroxyethyl (meth)acrylate, (meth)acrylic acid, and maleic acid;
vinyl ether-based monomers such as vinyl methyl ether and vinyl isobutyl ether; vinyl ketone-based monomers such as vinyl methyl ketone, vinyl ethyl ketone, and vinyl isopropenyl ketone;
polyolefins such as ethylene, propylene, and butadiene.

As the styrene acrylic resin, a polyfunctional polymerizable monomer can be used as necessary. Examples of the polyfunctional polymerizable monomer include diethylene glycol di(meth)acrylate, triethylene glycol di(meth)acrylate, tetraethylene glycol di(meth)acrylate, polyethylene glycol di(meth)acrylate, 1,6-hexandiol di(meth)acrylate, neopentyl glycol di(meth)acrylate, tripropylene glycol di(meth)acrylate, polypropylene glycol di(meth)acrylate, 2,2′-bis(4-((meth)acryloxy diethoxy)phenyl)propane, trimethylolpropane tri(meth)acrylate, tetramethylolmethane tetra(meth)acrylate, divinylbenzene, divinylnaphthalene, divinyl ether, and the like.

The toner particle preferably has a polyester resin D at the surface from the viewpoint of environmental stability.

The polyester resin D preferably has at least one selected from the group consisting of a monomer unit derived from an alcohol having an alicyclic structure and a monomer unit derived from carboxylic acid having an alicyclic structure as a monomer unit constituting a polymer chain. “Monomer unit” refers to a reacted form of a monomer substance in the polymer.

The polyester resin D is, for example, a polycondensation product of an acid component and an alcohol component. A polymer chain is formed by the polycondensation thereof. The polymer chain contains a structure in which a monomer unit obtained from the acid component and a monomer unit obtained from the alcohol component are bonded to each other by an ester bond. For example, these monomer units form a repeating unit. In the polyester resin D, at least one of the monomer unit obtained from the acid component and the monomer unit obtained from the alcohol component preferably has an alicyclic structure.

This alicyclic structure is incorporated into the polymer chain as a monomer unit as a constituent unit of the polymer chain, that is, by being directly linked to an adjacent monomer unit, and is not disposed in a group that binds to the polymer chain, for example, a side group or pendent group that does not have any repeating unit structure as a polymer.

The polyester resin D may have only a straight chain-like main chain or a branched chain-like chain having a main chain and a side chain as this polymer chain. In the case of the branched chain-like chain, it is possible to incorporate an alicyclic structure as a constituent unit of the main chain and/or the side chain.

The weight average molecular weight (Mw) of the polyester resin D is, for example, 5000 to 50000 and preferably 8000 to 20000.

An alicyclic compound refers to a compound having a non-aromatic cyclic structure. On the basis of a constituent element, the alicyclic structure is classified into an alicyclic hydrocarbon structure in which a non-aromatic cyclic structure is composed of carbon and hydrogen alone and an alicyclic heterocyclic structure in which a non-aromatic cyclic structure contains carbon, hydrogen, and other elements, and any of these alicyclic structures can be used.

Examples of a monomer (acid monomer) as the acid component containing the alicyclic hydrocarbon structure and a monomer (alcohol monomer) as the alcohol component include various monomers below.

Examples of the acid monomer include 1,4-cyclohexanedicarboxylic acid, 1,3-cyclohexanedicarboxylic acid, 1,2-cyclohexanedicarboxylic acid, 4-methyl-1,2-cyclohexanedicarboxylic acid, cis-4-cyclohexene-1,2-dicarboxylic acid, cis-1-cyclohexene-1,2-dicarboxylic acid, norbornane dicarboxylic acid, norbornene dicarboxylic acid, 1,3-adamantanedicarboxylic acid, 1,3,5-cyclohexanetricarboxylic acid, 1,2,4-cyclohexanetricarboxylic acid, 1,2,4,5-cyclohexanetetracarboxylic acid, 1,2,3,4,5,6-cyclohexanehexacarboxylic acid, methylcyclohexenetricarboxylic acid, and the like.

Examples of the alcohol monomer include 1,4-cyclohexanedimethanol, hydrogenated biphenol A, 1,4-cyclohexanediol, 1,2-cyclohexanediol, 1,3-cyclohexanediol, 4-(2-hydroxyethyl)cyclohexanol, 4-(hydroxymethyl)cyclohexanol, 4,4′-bicyclohexanol, 1,3-adamantandiol, and the like. Examples of the monomer having the alicyclic heterocyclic structure include isosorbide, spiroglycol, and the like as alcohol monomers.

In particular, it is more preferable that the main chain and/or side chain of the polyester resin has an isosorbide structure as a constituent unit of the polymer chain using isosorbide as the alcohol monomer. When the chain has the isosorbide structure, the surface layer of the toner becomes highly polar and is likely to electrostatically attract the hydrotalcite or vice versa as appropriate. As a result, the concentration of the hydrotalcite can be suppressed. That is, the polyester resin D preferably has a monomer unit derived from isosorbide.

The monomer unit derived from (corresponding to) isosorbide is represented by the following formula (H).

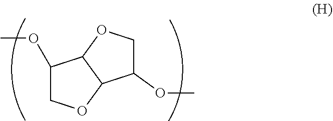

The polyester resin D can be prepared by a method in which, aside from the alcohol or carboxylic acid having the alicyclic structure, a dibasic acid or a derivative (carboxylic acid halide, ester, or acid anhydride) thereof, a divalent alcohol, as necessary, a tri- or higher functional polybasic acid, a derivative (carboxylic acid halide, ester, or acid anhydride) thereof, a monobasic acid, a tri- or higher functional alcohol, a monovalent alcohol, and the like are dehydrated and condensed.

Examples of the dibasic acid include aliphatic dibasic acids such as maleic acid, fumaric acid, itaconic acid, oxalic acid, malonic acid, succinic acid, dodecylsuccinic acid, dodecenylsuccinic acid, adipic acid, azelaic acid, sebacic acid, and decan-1,10-dicarboxylic acid; aromatic dibasic acids such as phthalic acid, tetrahydrophthalic acid, hexahydrophthalic acid, tetrabromophthalic acid, tetrachlorophthalic acid, het acid, himic acid, isophthalic acid, terephthalic acid, and 2,6-naphthalene dicarboxylic acid; and the like. Examples of the derivative of the dibasic acid include carboxylic acid halides, esterified products, and acid anhydrides of the aliphatic dibasic acids and the aromatic dibasic acids, and the like.

Examples of the divalent alcohol include aliphatic diols such as ethylene glycol, 1,2-propylene glycol, 1,4-butanediol, 1,5-pentanediol, 1,6-hexanediol, diethylene glycol, dipropylene glycol, triethylene glycol, and neopentyl glycol; bisphenols such as bisphenol A and bisphenol F; bisphenol A alkylene oxide adducts such as an ethylene oxide adduct of bisphenol A and a propylene oxide adduct of bisphenol A; aralkylene glycols such as xylylene glycol, and the like.

Examples of the tri- or higher-functional polybasic acid or an anhydride thereof include trimellitic acid, trimellitic anhydride, 1,3,5-cyclohexanetricarboxylic acid, 1,2,4-cyclohexanetricarboxylic acid, 1,2,4,5-cyclohexanetetracarboxylic acid, 1,2,3,4,5,6-cyclohexanehexacarboxylic acid, methylcyclohexentricarboxylic acid, methylcyclohexentricarboxylic anhydride, pyromellitic acid, pyromellitic anhydride, and the like.

### Charge Control Agent and Charge Control Resin

The toner particle may contain a charge control agent and/or a charge control resin. As the charge control agent, known charge control agents can be used, and particularly, a charge control agent having a high frictional charge speed and capable of stably maintaining a constant frictional charge amount is preferable. Furthermore, in a case where the toner particle is produced by a suspension polymerization method, a charge control agent having low polymerization inhibition and substantially not having a substance soluble in an aqueous medium is particularly preferable.

Examples of a charge control agent that controls the toner to be negatively charged include a monoazo metal compound, an acetylacetone metal compound, an aromatic oxycarboxylic acid, an aromatic dicarboxylic acid, oxycarboxylic acid and dicarboxylic acid-based metal compounds, aromatic oxycarboxylic acids, aromatic mono and polycarboxylic acids, metal salts, anhydrides, and esters thereof, phenol derivatives such as bisphenol, urea derivatives, metal-containing salicylic acid-based compounds, metal-containing naphthoic acid-based compounds, and charge control resins, and the like.

A charge control resin having a structure represented by the following formula (5) as an ionic functional group is preferably present at the surface of the toner particle. The charge control resin is preferably a vinyl-based resin and more preferably a styrene-based resin.

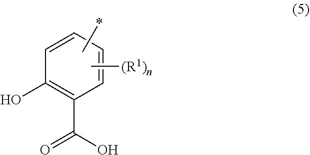

In the formula (5), R¹'s each independently represent an alkyl group having 1 to 18 carbon atoms or an alkoxy group having 1 to 18 carbon atoms, n represents an integer of 0 to 3, and * is a bonding site with a polymer.

When the toner particle has the charge control resin, not only do the charge build-up properties and the charge stability improve but the environmental stability also improves. The content of the charge control resin in the toner particle is preferably 0.1 to 3.0 parts by mass and more preferably 0.2 to 1.0 part by mass with respect to 100 parts by mass of the binder resin.

The resin having an ionic functional group only needs to have an ionic functional group of the formula (5). For example, a resin obtained by polymerizing vinyl salicylic acid or 1-vinyl phthalate is preferable. The electron control resin is preferably a vinyl-based resin (more preferably a styrene-based resin) having a structure derived from a monomer represented by the following formula (6).

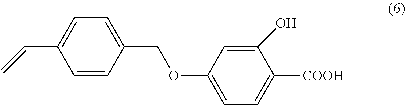 [SMILES: C=Cc1ccc(COc2ccc(C(=O)O)c(O)c2)cc1]

Examples of the alkyl groups as R¹ include a methyl group, an ethyl group, a propyl group, an isopropyl group, a butyl group, an isobutyl group, a s-butyl group, a t-butyl group, and the like, and examples of the alkoxy group include a methoxy group, an ethoxy group, a propoxy group, and the like. The main chain structure of the polymer is not particularly limited. Examples thereof include a vinyl-based polymer, a polyester-based polymer, a polyamide-based polymer, a polyurethane-based polymer, a polyether-based polymer, and the like. In addition, examples thereof also include hybrid-type polymers obtained by combining two or more thereof. Among those exemplified above, a vinyl-based polymer is preferable when the adhesion to a toner base particle is taken into account.

Examples of a charge control agent that controls the toner to be positively charged include modified products with nigrosine and a fatty acid metal salt; quaternary ammonium salts such as tributylbenzyl ammonium-1-hydroxy-4-naphthosulfonate and tetrabutylammonium tetrafluoroborate, and analogues thereof; onium salts such as phosphonium salts and lake pigments thereof; triphenylmethane dyes and lake pigments thereof (as laking agents, phosphotungstic phosphomolybdic acid, phosphotungstomolybdic acid, tannic acid, lauric acid, gallic acid, ferricyanic acid, ferrocyanide compounds, and the like); metal salts of higher fatty acids, charge control resins, and the like.

The toner particle preferably contains a charge control resin that controls the toner to be positively charged. Particularly, the toner particle preferably contains a charge control resin containing a quaternary ammonium salt and a quaternary ammonium base. When the toner particle contains the above, the adhesion of the hydrotalcite to the toner particle becomes appropriate, and the charge build-up properties and the charge stability improve.

### Release Agent

In the toner, as a release agent, a known wax can be used.

Specific examples thereof include petroleum-based wax, such as paraffin wax, microcrystalline wax, and petrolatum, and derivatives thereof, montan wax and derivatives thereof, hydrocarbon wax obtained by a Fischer-Tropsch method and derivatives thereof, polyolefin wax represented by polyethylene or polypropylene and derivatives thereof, and natural wax, such as carnauba wax or candelilla wax, and derivatives thereof, ester wax, and the like. Here, the derivatives include oxides, block copolymers with a vinyl-based monomer, and graft modified products.

As the ester wax, a mono-functional ester wax, a bifunctional ester wax, and a polyfunctional (tetrafunctional, hexafunctional, or the like) ester wax can be used. Hereinafter, examples of aliphatic ester waxes will be shown. The functional number indicates the number of ester groups contained in one molecule. For example, behenyl behenate is referred to as a monofunctional ester wax, and dipentaerythritol hexabehenate is referred to as a hexafunctional ester wax.

As described above, the toner particle preferably contains ester wax. The ester wax is preferably a polyfunctional ester wax having two or more ester groups and more preferably a bifunctional ester wax having two ester groups.

As a monofunctional aliphatic ester wax, a condensate of a monocarboxylic acid having 4 to 28 carbon atoms and a monoalcohol having 4 to 28 carbon atoms can be used. For example, at least one selected from the group consisting of stearyl stearate, behenyl stearate, stearyl behenate, and behenyl behenate is preferable, and at least one selected from the group consisting of behenyl behenate and behenyl stearate is more preferable.

As a bifunctional aliphatic ester wax, a condensate of a dicarboxylic acid and a monoalcohol or a condensate of a diol and a monocarboxylic acid can be used.

Examples of the dicarboxylic acid include adipic acid, pimelic acid, suberic acid, azelaic acid, sebacic acid, and dodecanedioic acid.

Examples of the diol include ethylene glycol, 1,6-hexandiol, 1,7-heptandiol, 1,8-octandiol, 1,9-nonandiol, 1,10-decanedidiol, 1,11-undecanedidiol, and 1,12-dodecanedidiol.

As the monoalcohol that is condensed with the dicarboxylic acid, an aliphatic alcohol is preferable. Specific examples thereof include tetradecanol, pentadecanol, hexadecanol, heptadecanol, octadecanol, nonadecanol, eicosaol, docosanol, tricosanol, tetracosanol, pentacosanol, hexacosanol, octacosanol, and the like.

Examples of the monocarboxylic acid that is condensed with the diol include lauric acid, myristic acid, palmitic acid, margaric acid, stearic acid, tuberculostearic acid, arachidic acid, behenic acid, lignoceric acid, cerotic acid, and the like.

Examples of the trifunctional ester wax include a condensate of a glycerin compound and a monofunctional aliphatic carboxylic acid.

Examples of the tetrafunctional ester wax include a condensate of pentaerythritol and a monofunctional aliphatic carboxylic acid and a condensate of diglycerin and an aliphatic carboxylic acid. Examples of the pentafunctional ester wax include a condensate of triglycerin and a monofunctional aliphatic carboxylic acid. Examples of the hexafunctional ester wax include a condensate of dipentaerythritol and a monofunctional aliphatic carboxylic acid and a condensate of tetraglycerol and a monofunctional aliphatic carboxylic acid.

In addition, the content of the release agent is preferably from 1.0 part by mass to 30.0 parts by mass with respect to 100.0 parts by mass of the binder resin. The content of the ester wax in the toner particle is preferably 1.0 to 10.0 parts by mass and more preferably 2.0 to 8.0 parts by mass with respect to 100 parts by mass of the binder resin.

### Coloring Agent

The toner particle may contain a coloring agent. As the coloring agent, a known pigment or dye can be used. From the viewpoint of excellent weather resistance, a pigment is preferable as the coloring agent.

Examples of a cyan-based coloring agent include copper phthalocyanine compounds and derivatives thereof, anthraquinone compounds, base dye lake compounds, and the like.

Specific examples thereof include the following: C.I. Pigment Blue 1, 7, 15, 15:1, 15:2, 15:3, 15:4, 60, 62, and 66.

Examples of a magenta-based coloring agent include condensed azo compounds, diketopyrrolopyrrole compounds, anthraquinone compounds, quinacridone compounds, basic dye lake compounds, naphthol compounds, benzimidazolone compounds, thioindigo compounds, perylene compounds, and the like.

Specific examples thereof include the following: C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, and 254, and C.I. Pigment Violet 19.

Examples of a yellow-based coloring agent include condensed azo compounds, isoindolinone compounds, anthraquinone compounds, azo metal complexes, methine compounds, allylamide compounds, and the like.

Specific examples thereof include the following: C.I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

Examples of a black coloring agent include coloring agents colored black using the yellow-based coloring agent, the magenta-based coloring agent, or the cyan-based coloring agent, carbon black, and magnetic bodies.

These coloring agents can be used singly or as a mixture, and these can be used in a solid solution state. The content of the coloring agent used is preferably from 1.0 part by mass to 20.0 parts by mass relative to 100.0 parts by mass of the binder resin. In the case of applying the production method using a magnetic body in an aqueous medium to be described below, it is also possible to perform a hydrophobic treatment for the purpose of stably incorporating the magnetic body into the resin.

### Average Circularity of Toner

The average circularity of the toner is preferably from 0.960 to 0.995. When the average circularity of the toner is within the above range, the charge build-up properties improve. A method for measuring the average circularity of the toner will be described below.

### Method for Producing Toner

A method for producing a toner is not particularly limited, and a known method such as a pulverization method, a suspension polymerization method, a dissolution suspension method, an emulsion aggregation method, or a dispersion polymerization method can be used. Among them, the suspension polymerization method is preferable since the average circularity of the toner can be highly controlled.

A weight average particle size (D4) of the toner particle is preferably 4.0 to 12.0 μm and more preferably 5.0 to 10.0 μm.

### Method for Measuring Each Physical Property

Next, a method for measuring each physical property will be described.

### Method for Isolating Strontium Titanate Fine Particle a, Silica Fine Particle B, and Hydrotalcite Particle C

In the case of measuring the physical properties of the strontium titanate fine particle A, the silica fine particle B, the hydrotalcite particle C, and the toner particle from the toner, it is possible to separate and measure the strontium titanate fine particle A and other external additives from the toner.

The strontium titanate fine particle A or the other external additives are removed by ultrasonically dispersing the toner in methanol and left to stand for 24 hours. The precipitated toner particle, and the strontium titanate fine particle A or the other external additives dispersed in a supernatant liquid are separated, collected, and sufficiently dried, whereby the toner particle can be isolated. In addition, the supernatant liquid is treated by centrifugation, whereby the strontium titanate fine particle A, the silica fine particle B, the hydrotalcite particle C can be isolated.

### Contents of Strontium Titanate Fine Particle a, Silica Fine Particle B, and Hydrotalcite Particle C

The strontium titanate fine particle A, the silica fine particle B, the hydrotalcite particle C are isolated from the toner by the above-described method. The masses of the resultant toner particle, strontium titanate fine particle A, silica fine particle B, and hydrotalcite particle C are measured. From the mass of the toner particle and the masses of the strontium titanate fine particle A, the silica fine particle B, and the hydrotalcite particle C thus obtained, the content of each with respect to 100 parts by mass of the toner particle is obtained.

Method for Measuring Number Average Particle Size of Primary Particle of Strontium Titanate Fine Particle A, Number Average Particle Size of Si-Containing Protrusion Portions, Number Average Particle Size of Silica Fine Particle B, and Number Average Particle Size of Hydrotalcite Particle C

The number average particle sizes of the primary particle of the external additives such as the strontium titanate fine particle A and the number average particle size of the primary particle of the Si-containing protrusion portions are measured using a transmission electron microscope (TEM) “JEM 2800” (manufactured by JEOL Ltd.). The strontium titanate fine particle A, silica fine particle B, and hydrotalcite particle C (hereinafter simply described as the external additives) separated by the above-described procedure can be used.

First, a measurement sample is prepared. 1 mL of isopropanol is added to 5 mg of each external additive to be measured and dispersed with an ultrasonic dispersing machine (ultrasonic washing machine) for five minutes. One drop of the dispersion was then dropped onto a microgrid with a support membrane (150 mesh) for TEM and dried, thereby preparing a measurement sample.

Next, an image is acquired with a transmission electron microscope (TEM) under the conditions of an accelerating voltage of 200 kV and a magnification at which the external additive in the visual field can be sufficiently measured (for example, 200000 to 1000000 times), and the particle sizes of 100 primary particles of the external additive are randomly measured to obtain the number average particle size. The particle sizes of the primary particle are measured using image processing software “Image-Pro Plus ver. 4.0 (manufactured by Media Cybernetics Co., Ltd.).”

As the particle sizes of the external additives other than the protrusion portion, the major axes are measured. The protrusion portion will be described below.

The Si-containing protrusion portion is determined by performing the secondary electron shape image (SEI) observation and EDS mapping measurement of the strontium titanate fine particle A separated by the above-described method using a transmission electron microscope (TEM) “JEM 2800” (manufactured by JEOL Ltd.). In the EDS mapping measurement, EDS mapping can be measured with high sensitivity using a silicon drift detector having a large detection element area. The conditions will be shown below.

### Shape Image Acquisition Conditions

Mode: STEM observation mode
Accelerating voltage: 200 kV
Magnification: 1,000,000 times
Probe size: 1 nm
Detector: Secondary electron detector (SEI detector)
SEI image size: 1024×1024 pixels

### STEM-EDS Element Mapping Image Acquisition Conditions

A STEM-EDS element mapping image is acquired in the same field of view as the SEI image observation field of view.
EDS detector: JED-2300 T dry SD100GV detector from JEOL Ltd. (detector element area: 100 mm²)
EDS analyzer: NORAN System7 manufactured by Thermo Fisher Scientific Inc.
Drift correction factor: 2
Dwell time: 30 μs
Accumulation count: 100 frames
X-ray count rate: 4000 to 10000 cps
Element mapping image size: 256×256 pixels

A quantitative map image was extracted from the collected spectral mapping data using a quantitative map mode in the measurement command of NORAN System7 described above. At that time, the set values were as follows.
Kernel size: 3×3
Quantitative map setting: High (slow)
Filter fit type: High precision (slow)

First, a shape image of the strontium titanate fine particle A is acquired. After that, EDS element quantitative mapping images of the Si element and the Sr element are each acquired at the same magnification from the same position, and these EDS element mapping images are overlapped. Regarding a portion where the Si mapping and the Sr mapping overlap, it is difficult to finely separate parts containing Si. On the other hand, in the outer peripheral portion of the strontium titanate fine particle A, a region where only Si is mapped is present outside of a Sr mapping region, and it is thus possible to clearly confirm a portion containing Si. In the outer peripheral portion where Si being contained has been confirmed, a protrusion portion is determined from the shape image acquired previously. In protrusions that are observed in the outer peripheral portion containing Si, the valley parts at both ends of the protrusion are connected with a straight line, and when the distance between the apex of the protrusion and the straight line is 1 nm or more, the protrusion is regarded as the protrusion portion in the present application. In addition, the length of the straight line connecting the valley parts at both ends of the protrusion is regarded as the particle size of the protrusion portion.

### Si/Sr Ratio of Strontium Titanate Fine Particle A

The contents (mass) of Si and Sr in the strontium titanate fine particle A can be obtained with a fluorescent X-ray analyzer. 1 g of a sample is weighed in a dedicated cup for powder measurement recommended by Malvern Panalytical Ltd. to which a dedicated film has been pasted using a wavelength dispersive X-ray fluorescence spectrometer Axios Advanced (manufactured by Malvern Panalytical Ltd.), and elements from Na through U in the strontium titanate fine particle A are measured by an FP method under a He atmosphere in the atmosphere.

At that time, all of the detected elements are assumed to be oxides, the total mass thereof is set to 100%, and the contents (mass %) of a Si oxide and a Sr oxide with respect to the total mass are obtained as equivalent values of the oxides with software Spectra Evaluation (version 5.0L). After that, the Si/Sr (mass ratio) is obtained by removing oxygen from the quantitative results.

### Measurement of Amount of C in Strontium Titanate Fine Particle A

The amount of C (carbon amount) derived from a hydrophobic treatment agent for the strontium titanate fine particle A is measured using a carbon-sulfur analyzer (trade name: EMIA-320) manufactured by Horiba, Ltd.

0.3 g of the strontium titanate fine particle A, which is a sample, is precisely weighed and put into a crucible for the carbon-sulfur analyzer. 0.3 g±0.05 g of tin (spare part number 9052012500) and 1.5 g±0.1 g of tungsten (spare part number 9051104100) are added thereto as combustion aids.

After that, the silica fine particle is heated at 1100° C. in an oxygen atmosphere in accordance with an instruction manual attached to the carbon-sulfur analyzer. As a result, a hydrophobic group derived from the hydrophobic treatment agent at the surface of the strontium titanate fine particle A is pyrolyzed into CO₂, and the amount thereof is thus measured. The amount of C (mass %) contained in the strontium titanate fine particle A is obtained from the amount of the obtained CO₂.

### Measurement of Powder Specific Resistance Value of Strontium Titanate Fine Particle A

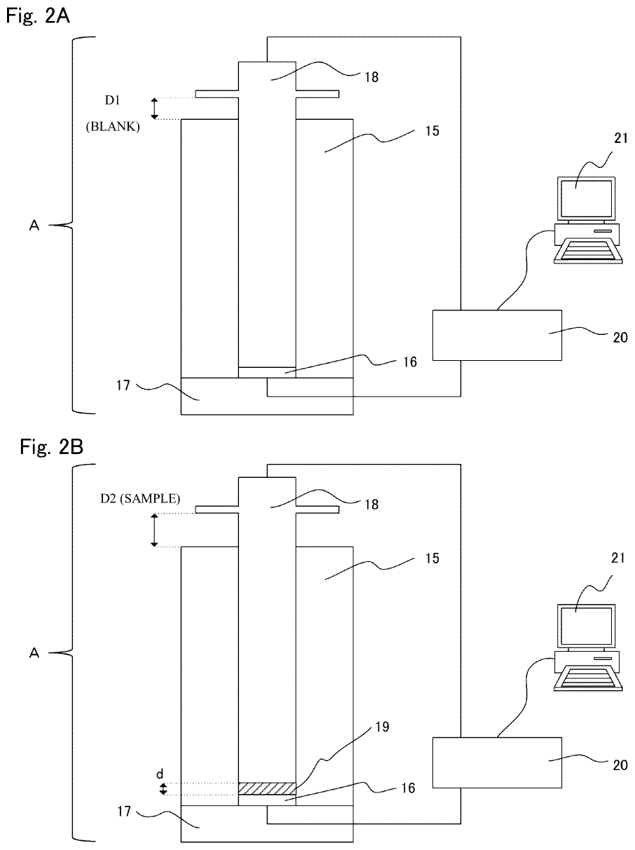

The resistance of the strontium titanate fine particle A is measured using a measuring instrument schematically shown in FIGS. 2A and 2B. In the case of measuring a sample, the sample is left to stand in an environment of a temperature of 23° C. and a humidity of 50% RH for 24 hours, and the resistance is then measured. A resistance measurement cell A is composed of a cylindrical PTFE resin container 15 having a hole with a cross-sectional area of 2.4 cm², a lower electrode (made of stainless steel) 16, a support base (made of a PTFE resin) 17, and an upper electrode (made of stainless steel) 18. The cylindrical PTFE resin container 15 is placed on the support base 17, 0.7 g of a sample 19 is loaded thereinto, the upper electrode 18 is placed on the loaded sample 19, and the thickness of the sample is measured. The thickness when the sample is not present beforehand is indicated by D1 (blank) (FIG. 2A), the thickness of the actual sample when loaded as much as 0.7 g is indicated by d, and the thickness when the sample is loaded is indicated by D2 (sample) (FIG. 2B), the thickness d of the sample is represented by the following equation.

$$d = D 2 ( sample ) - D 1 ( blank )$$

In addition, a voltage is applied between the electrodes, and a current flowing at that time is measured, whereby a specific resistance can be obtained. In the measurement, an electrometer 20 (Keithley 6517 manufactured by Tektronix, Inc.) and a control computer 21 are used. Regarding the measurement conditions, the contact area S between the sample and the electrode is set to 2.4 cm², and the load on the upper electrode is set to 230 g. Regarding the voltage application conditions, an IEEE-488 interface is used for the control between the control computer and the electrometer, and screening is performed by applying each voltage of 1 V, 2 V, 4 V, 8 V, 16 V, 32 V, 64 V, 128 V, 256 V, 512 V, and 1000 V for one second using an automatic range function of the electrometer.

At that time, the electrometer determines whether or not the application of a maximum of 1000 V (for example, 10000 V/cm as an electric field intensity in the case of a sample thickness of 1.00 mm) is possible, and in a case where of an overcurrent flows, “VOLTAGE SOURCE OPERATE” blinks. Then, the applied voltage is lowered, an applicable voltage is further screened, and the maximum value of the applied voltage is automatically determined. After that, the measurement is performed.

A resistance value is measured from a current value after one of the five voltages obtained by equally dividing the maximum voltage value by five is held for 30 seconds as each step. For example, in a case where the maximum applied voltage is 1000 V, voltages are applied in ascending order and then descending order at intervals of 200 V, which is 1/5 of the maximum applied voltage, such as 200 V (first step), 400 V (second step), 600 V (third step), 800 V (fourth step), 1000 V (fifth step), 1000 V (sixth step), 800 V (seventh step), 600 V (eighth step), 400 V (ninth step), and 200 V (tenth step), and a resistance value is measured from a current value after the voltage is held for 30 seconds in each step. Those are treated with the computer, whereby the electric field intensity and the specific resistance are calculated and plotted in a graph. A specific resistance at an electric field intensity of 1000 V/cm is read from the plot. The specific resistance and the electric field intensity can be obtained by the following equation:

$$Specific resistance ( Ω \cdot cm ) = ( applied voltage ( V ) / measured current ( A ) ) \times S ( {cm}^{2} ) / d ( cm )$$

$$Electric field intensity ( V / cm ) = applied voltage ( V ) / d ( cm )$$

### Measurement of Weight Average Particle Size (D4) of Toner Particle

The toner particle is measured with 25,000 effective measurement channels using a precision particle size distribution measuring instrument “Coulter Counter Multisizer 3” (registered trademark, manufactured by Beckman Coulter, Inc.) by a pore electrical resistance method provided with an 100 μm aperture tube and dedicated software “Beckman Coulter Multisizer 3 Version 3.51” (manufactured by Beckman Coulter, Inc.) attached for setting measurement conditions and analyzing measurement data, the measurement data is analyzed, and the weight-average particle size (D4) is calculated.

### Method for Calculating SP Value

The SP value is calculated in accordance with a calculation method proposed by Fedors. For an atom or atomic group in the molecular structure, the evaporation energy (Δei) (cal/mol) and the molar volume (Δvi) (cm³/mol) are obtained from the table described in “polym. Eng. Sci., 14 (2), 147 to 154 (1974).” (4.184×ΣΔei/ΣΔvi)^{1/2} is regarded as the SP value (J/cm³)^{1/2}.

### Method for Measuring Average Circularity of Toner

The average circularities of the toner and the toner particle are measured and analyzed with a flow-type particle image analyzer (trade name: FPIA-3000, manufactured by Sysmex Corporation) under the following conditions. A specific measurement method is as described below.

First, 20 mL of ion exchanged water from which an impurity solid matter or the like has been removed in advance is put into a glass container. 0.2 mL of a diluted solution obtained by diluting CONTAMINON N (manufactured by Wako Pure Chemical Industries, Ltd.: a 10 mass % aqueous solution of a neutral detergent for washing a precision measuring instrument having a pH of 7 composed of a nonionic surfactant, an anionic surfactant, and an organic builder) with ion exchange water to 3 parts by mass is added thereto as a dispersant.

Furthermore, 0.02 g of a measurement sample is added thereto, and a dispersion treatment is performed for two minutes using an ultrasonic disperser to produce a dispersion for measurement. At that time, the dispersion is appropriately cooled so that the temperature thereof reaches 10° C. to 40° C. As the ultrasonic disperser, a desktop ultrasonic washer/disperser (for example, “VS-150” (manufactured by Velvo-Clear)) having an oscillation frequency of 50 kHz and an electrical output of 150 W is used, a predetermined amount of ion exchanged water is put into a water tank, and 2 mL of the CONTAMINON N is added into this water tank.

For the measurement, a flow-type particle image analyzer equipped with “UPlanApro” (magnification: 10 times, numerical aperture: 0.40) as an objective was used, and a particle sheath (trade name: PSE-900A, manufactured by Sysmex Corporation) was used as a sheath solution. The dispersion prepared in accordance with the above-described procedure is introduced into the flow-type particle image analyzer, and 3000 toner particles are measured in an HPF measurement mode and in a total count mode. In addition, the binarization threshold value upon particle analysis is set to 85%, the analyzed particle size is limited to a circle equivalent diameter of at least 1.985 μm and less than 39.69 μm, and the average circularity of the toner particle is obtained.

Upon the measurement, automatic focus adjustment is performed using a standard latex particle (for example, “RESEARCH AND TEST PARTICLES Latex Microsphere Suspensions 5200A” manufactured by Duke Scientific Corp. is diluted with ion exchanged water) before the start of the measurement.

### Method for Measuring Bragg Angle Θ of Strontium Titanate Fine Particle A

The Bragg angle Θ of the inorganic fine particle is measured using a powder X-ray diffractometer “SmartLab” (sample horizontal strong X-ray diffractometer manufactured by Rigaku Holdings Corporation).

In addition, for the calculation of the Sb/Sa from the obtained peak, “PDXL2 (version 2.2.2.0)” of analysis software attached to the above-described instrument is used.

As a measurement sample, the toner or the toner from which the strontium titanate fine particle has been isolated is used, and the Bragg angle Θ is measured by the following procedure. In the following example, the Bragg angle Θ is measured with the produced strontium titanate fine particle A.

### Preparation of Sample

The measurement sample is uniformly put into a Boro-silicate capillary (W. Muller GmbH) having a diameter of 0.5 mm and then measured.

### Measurement Conditions

Tube: Cu
Optical system: CBO-E
Sample stand: Capillary sample stand
Detector: D/tex Ultra 250 detector
Voltage: 45 kV
Current: 200 mA
Start angle: 10°
End angle: 90°
Sampling width: 0.02°
Speed measurement time set value: 10
IS: 1 mm
RS1: 20 mm
RS2: 20 mm
Attenuator: Open
Capillary rotation speed set value: 100

As other conditions, the initial set value of the instrument is used.

### Analysis

First, a peak separation treatment is performed on the obtained peak using software “PDXL2” attached to the instrument. Peak separation is achieved by executing optimization using a “split type Voigt function” that can be selected in PDXL, and the obtained integrated intensity value is used.

This determines the value of 2Θ for the diffraction peak top and the area thereof. The Sb/Sa is calculated from the peak area of a predetermined 2Θ value. At this time, in a case where the peak separation calculation result and the actually measured spectrum are significantly shifted, the calculation result and the actually measured spectrum are adjusted to match each other by a treatment such as manual setting of the baseline.

### EXAMPLES

Hereinafter, the toner of the present disclosure will be described in detail using Examples and Comparative Examples, but the present disclosure is not limited to these Examples. Note that, in the description of the following Examples, “part(s)” are mass-based unless particularly otherwise specified.

### Production Example of Strontium Titanate Fine Particle A1

After an iron removal and bleaching treatment was performed on metatitanic acid produced by a sulfuric acid method, a 3 mol/L sodium hydroxide aqueous solution was added thereto to adjust the pH to 9.0, a desulfurization treatment was performed thereon, the metatitanic acid was neutralized with 5 mol/L hydrochloric acid up to a pH of 5.6, and filtration washing was performed thereon. Water was added to a washed cake to produce TiO₂, the TiO₂ was made into a 1.90 mol/L slurry, hydrochloric acid was then added thereto to adjust the pH to 1.4, and a peptization treatment was performed thereon.

The desulfurized and peptized metatitanic acid was made into TiO₂, 1.90 mol of the TiO₂ was collected and injected into a 3 L reaction vessel. To the peptized metatitanic acid slurry, 2.185 mol of a strontium chloride aqueous solution was added so that SrO/TiO₂ (molar ratio) reached 1.15, and the TiO₂ concentration was then adjusted to 1.039 mol/L.

Next, a sodium silicate aqueous solution was prepared so that the amount of Si added reached 5.0 mol % relative to strontium and heated to 90° C. while being stirred and mixed, and 440 mL of a 10 mol/L sodium hydroxide aqueous solution was added thereto under ultrasonic vibration over 55 minutes.

After that, the sodium silicate aqueous solution was continuously stirred at 95° C. for 45 minutes, then, injected into ice water, and quenched to terminate the reaction.

The reaction slurry was heated up to 70° C., 12 mol/L of hydrochloric acid was added thereto until the pH reached 5.0, the slurry was continuously stirred for one hour, and a resultant precipitate was decantation-washed. After separation by filtration, the precipitate was dried in the atmosphere at 120° C. for eight hours. Subsequently, 300 g of a dried product was injected into a dry particle composition device (manufactured by Hosokawa micron corporation, NOBILTA NOB-130). The dried product was treated at a treatment temperature of 30° C. for 10 minutes with a rotary treatment blade at 90 m/sec. Furthermore, hydrochloric acid was added to the dried product until the pH reached 0.1, and the dried product was continuously stirred for one hour. A resultant precipitate was decantation-washed. A slurry containing the precipitate was adjusted to 40° C., and hydrochloric acid was added thereto to adjust the pH to 2.5.

Next, 14 mass % of isobutyltrimethoxysilane was stirred and mixed for one hour, then, added to the solid content, continuously stirred and held for 10 hours. A 5N sodium hydroxide solution was added thereto to adjust the pH to 6.5, stirring was continued for one hour, then, filtration and washing were performed, and a resultant cake was dried in the atmosphere at 120° C. for eight hours. A resultant strontium titanate fine particle was regarded as a strontium titanate fine particle A1.

At the surface of the strontium titanate fine particle A1, a protrusion portion in which a part of silica fine particle had been embedded or which had been formed by the fixation of the silica fine particle was present. The particle size of the silica fine particle forming the protrusion portion was less than 5 nm.

### Production Examples of Strontium Titanate Fine Particles A2 to A22

Strontium titanate fine particles A2 to 22 were obtained by changing the amount of Si added, the surface treatment component, and the amount thereof added as shown in Table 1 and appropriately adjusting the addition rate of “440 mL of a 10 mol/L sodium hydroxide aqueous solution”, stirring conditions, ultrasonic dispersion conditions, and treatment time with a dry particle composition device in the production example of the strontium titanate fine particle A1.

At the surfaces of the strontium titanate fine particles A2 to A17, protrusion portions in which a part of the silica fine particle was embedded or protrusion portions formed by the fixation of the silica fine particle were present. The particle size of the silica fine particle forming the protrusion portion was less than 5 nm.

On the other hand, at the surfaces of the strontium titanate fine particles A18 to A22, no protrusion portions of the silica fine particle were present.

### Production Example of Silica Fine Particle B1

Untreated dry silica (BET specific surface area 200 m²/g) was injected into a reactor and heated to 330° C. in a state of being fluidized by stirring. Subsequently, 20 parts of dimethyl silicone oil (polydimethylsiloxane: KF-96-50CS manufactured by Shin-Etsu Chemical Co., Ltd.) was sprayed as a surface treatment agent to 100 parts of the untreated dry silica. After that, the components were continuously heated and stirred for one hour and reacted to be coated, thereby obtaining a silica fine particle B1.

### Production Examples of Silica Fine Particles B2 to B4

Silica fine particles B2 to B4 were obtained in the same manner as in the production example of the silica fine particle B1 except that the BET specific surface area of the untreated dry silica and the number of parts of the surface treatment agent were changed as shown in Table 2.

### Production Example of Hydrotalcite Particle C1

A mixed aqueous solution (liquid A) of 1.03 mol/L of magnesium chloride and 0.239 mol/L of aluminum sulfate, 0.753 mol/L of a sodium carbonate aqueous solution (liquid B), and 3.39 mol/L of a sodium hydroxide aqueous solution (liquid C) were prepared.

Next, the liquid A, the liquid B, and the liquid C were added into a reaction vessel using a metering pump at a flow rate at which the volume ratio between the liquid A and the liquid B reached 4.5:1, the pH value of a reaction solution was kept in a range of 9.3 to 9.6 with the liquid C, and a reaction was performed at a temperature of 40° C. to generate a precipitate. The precipitate was filtered, washed, then, re-emulsified in ion exchanged water, thereby obtaining a hydrotalcite slurry of the raw materials. The concentration of hydrotalcite in the obtained hydrotalcite slurry was 5.6 mass %.

After that, the hydrotalcite slurry was filtered with a membrane filter having a pore size of 0.5 μm and washed with ion exchanged water. The obtained hydrotalcite was dried at 40° C. in a vacuum overnight, and a crushing treatment was then performed until a desired particle size was obtained, thereby obtaining a hydrotalcite particle C1.

### Production Examples of Hydrotalcite Particles C2 to C5

Hydrotalcite particles C2 to C5 were obtained in the same manner as in the production example of the hydrotalcite particle Cl except that the crushing treatment conditions were changed so that the particle sizes became as shown in Table 3.

### Production Example of Polyester Resin D1

100 parts by mass of a mixture in which raw material monomers were mixed in charge fractions shown in Table 4 and 0.55 parts by mass of tin (II) 2-ethylhexanoate as a catalyst were put into a 6 liter four-neck flask equipped with a nitrogen introduction tube, a dehydration tube, a stirrer, and a thermocouple and reacted under a nitrogen atmosphere at 200° C. for six hours. Furthermore, trimellitic anhydride was added at 210° C. to perform the reaction under reduced pressure of 40 kPa, and the reaction was continued until the weight average molecular weight (Mw) reached 12100. A resultant polyester resin is regarded as a polyester resin D1.

### Production Examples of Polyester Resin D2

A polyester resin D2 was obtained in the same manner as the production example of the polyester resin D1, except that the raw material monomers were changed as shown in Table 4.

### Production Example of Charge Control Resin E

9.2 g of a polymerizable monomer represented by the following structural formula (6) and 60.1 g of styrene were dissolved in 42.0 mL of DMF, stirred for one hour under nitrogen bubbling, and then heated to 110° C. A mixed liquid of 2.1 g of tert-butylperoxyisopropyl monecarboxylate (trade name PERBUTYL I, manufactured by NOF Corporation) and 42 mL of toluene was added dropwise as an initiator to this reaction solution. The reaction solution was further reacted at 110° C. for four hours. After that, the reaction solution was cooled, and 1 L of methanol was added dropwise thereto, thereby obtaining a precipitate. The obtained precipitate was dissolved in 120 mL of THF and then added dropwise to 1.80 L of methanol, a white precipitate was precipitated, filtered, and dried at 90° C. under reduced pressure, thereby obtaining a charge control resin E.

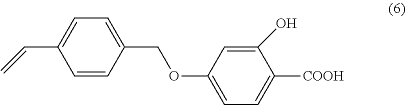 [SMILES: C=Cc1ccc(COc2ccc(C(=O)O)c(O)c2)cc1]

### Production Example of Vinyl Resin F

300 parts of xylene was injected into an autoclave equipped with a stirrer, a thermometer, a nitrogen introduction tube, a pressure reducing device, and a dehydration tube, heated under nitrogen substitution, and refluxed at a liquid temperature of 140° C. A mixed liquid of the following materials was added thereto, and polymerization was then performed at a polymerization temperature of 160° C. and a reaction pressure of 0.150 MPa for five hours.
91.50 parts of styrene,
1.00 part of butyl acrylate,
2.50 parts of methyl methacrylate,
2.50 parts of methacrylic acid
2.50 parts of 2-hydroxyethyl methacrylate,
2.00 parts of a polymerization initiator (di-tert-butyl peroxide)

After that, a desolvation step was performed under reduced pressure for three hours, xylene was removed, and pulverization was performed, thereby obtaining a vinyl resin F.

### Production Example of Toner Particle 1

A toner particle was produced according to the following procedure.

### Preparation of Pigment Masterbatch

The following materials were injected into an attritor (manufactured by Mitsui Miike Machinery Company, Limited) and further dispersed at 220 rpm for five hours using a zirconia particle having a diameter of 1.7 mm, thereby obtaining a pigment masterbatch.
60.0 parts of styrene
7 parts of a cyan pigment (C.I. Pigment Blue 15:3, manufactured by Dainichiseika Color & Chemicals Mfg. Co., Ltd.)

### Preparation of First Aqueous Medium

After 2.9 parts of sodium phosphate dodecahydrate was injected into 353.8 parts of ion exchanged water and warmed to 60° C. while being stirred using a TK type homomixer (manufactured by Tokushu Kika Kogyo Co., Ltd.), a calcium chloride aqueous solution obtained by adding 1.7 parts of calcium chloride dihydrate to 11.7 parts of ion exchanged water and a magnesium chloride aqueous solution obtained by adding 0.5 parts of magnesium chloride to 15.0 parts of ion exchanged water were added thereto and stirred, thereby obtaining a first aqueous medium containing a dispersion stabilizer.
Preparation of Polymerizable Monomer Composition
15.0 parts of styrene
25.0 parts of n-butyl acrylate
5.0 parts of bifunctional ester wax (ethylene glycol distearate)
Hydrocarbon wax, melting point: 79° C. 5.0 parts
67.0 parts of the pigment masterbatch
13.0 parts of the polyester resin D
0.5 parts of the charge control resin E
0.1 parts of a positive charge control resin (trade name: FCA-676P, manufactured by Fujikura Kasei Co., Ltd., quaternary ammonium group-containing styrene acrylic resin)

The above materials were uniformly dispersed and mixed using an attritor (manufactured by Mitsui Miike Machinery Company, Limited) and then warmed to 60° C., 8.0 parts of paraffin wax (manufactured by Nippon Seiro Co., Ltd., HNP-9) was added thereto, mixed therewith as hydrocarbon wax, and dissolved therein, thereby obtaining a polymerizable monomer composition.

### Preparation of Second Aqueous Medium

After 0.6 parts of sodium phosphate dodecahydrate was injected into 166.8 parts of ion exchanged water and warmed to 60° C. while being stirred using a paddle stirring blade, a calcium chloride aqueous solution obtained by adding 0.3 parts of calcium chloride dihydrate to 2.3 parts of ion exchanged water was added thereto and stirred, thereby obtaining a second aqueous medium containing a dispersion stabilizer.

### Granulation

The polymerizable monomer composition was injected into the first aqueous medium, this granulation liquid was treated with CAVITRON (manufactured by Eurotec Limited.) for one hour at a rotor circumferential speed of 29 m/s to be uniformly dispersed and mixed, furthermore, 7.0 parts of t-butyl peroxypivalate was injected thereinto as a polymerization initiator, and the mixture was granulated at 60° C. in a N₂ atmosphere with CLEARMIX (manufactured by M Technique Co., Ltd.) at a circumferential speed of 22 m/s for 10 minutes under stirring, thereby obtaining a granulation liquid containing liquid droplets of the polymerizable monomer composition.

### Polymerization/Distillation/Drying

The granulation liquid was injected into the second aqueous medium and reacted at 74° C. for three hours while being stirred with a paddle stirring blade. After the end of the reaction, the granulation liquid was heated to 98° C. and distilled for three hours to obtain a reaction slurry. After that, as a cooling step, 0° C. water was charged into the reaction slurry, the reaction slurry was cooled from 98° C. to 45° C. at a rate of 100° C./min, then, further heated, and held at 50° C. for three hours.

After that, the reaction slurry was naturally cooled to 25° C. at room temperature. The naturally cooled reaction slurry was washed by applying hydrochloric acid thereto, filtered, and dried, thereby obtaining a toner particle 1 having a weight average particle size of 7.5 μm.

### Production Example of Toner Particle 2

A toner particle 2 having a weight average particle size of 7.6 μm was obtained in the same manner as the toner particle 1 except that “polyester resin D1” was changed to “polyester resin D2.”

### Production Example of Toner Particle 3

A toner particle 3 having a weight average particle size of 7.4 μm was obtained in the same manner as the toner particle 1 except that “polyester resin D1” was changed to “vinyl resin F.”

### Production Example of Toner Particle 4

A toner particle 4 having a weight average particle size of 7.4 μm was obtained in the same manner as the toner particle 1 except that “polyester resin D1” was changed to “vinyl resin F” and “positive charge control resin” was removed.

### Production Example of Toner Particle 5

A toner particle 5 having a weight average particle size of 7.4 μm was obtained in the same manner as the toner particle 1 except that “polyester resin D1” was changed to “vinyl resin F” and “charge control resin E” and “positive charge control resin” were removed.

### Production Example of Toner Particle 6

A toner particle 6 having a weight average particle size of 7.4 μm was obtained in the same manner as the toner particle 1 except that “bifunctional ester wax (ethylene glycol distearate)” was changed to “tetrafunctional ester wax (pentaerythritol tetrastearate).”

### Production Example of Toner Particle 7

A toner particle 7 having a weight average particle size of 7.4 μm was obtained in the same manner as the toner particle 1 except that “bifunctional ester wax (ethylene glycol distearate)” was changed to “trifunctional ester wax (glycerin tribehenate).”

### Production Example of Toner Particle 8

A toner particle 8 having a weight average particle size of 7.4 μm was obtained in the same manner as the toner particle 1 except that “bifunctional ester wax (ethylene glycol distearate)” was changed to “monofunctional ester wax (behenyl behenate).”

### Production Example of Toner Particle 9

A toner particle 9 having a weight average particle size of 7.4 μm was obtained in the same manner as the toner particle 1 except that “ester wax (ethylene glycol distearate)” was removed.

### Production Example of Toner Particle 10

### Preparation of Styrene Acrylic Resin Particle Dispersion

Styrene: 75 parts
n-Butyl acrylate: 25 parts

A solution containing 1.0 part of an anionic surfactant (DOWFAX manufactured by Dow Inc.) dissolved in 60 parts of ion exchanged water was added to a solution obtained by mixing and dissolving the above-described materials, and dispersed and emulsified in a flask to prepare an emulsion of the monomers. Subsequently, 2.0 parts of an anionic surfactant (DOWFAX manufactured by Dow Inc.) was dissolved in 90 parts of ion exchanged water, 2.0 parts of the emulsion of the monomers was added thereto, and 10 parts of ion exchanged water containing 1.0 part of ammonium persulfate dissolved therein was injected thereinto.

After that, the remainder of the emulsion of the monomers was injected thereinto over three hours, nitrogen substitution in the flask was performed, the solution in the flask was heated up to 65° C. under stirring, and emulsion polymerization was continued for five hours, and a styrene acrylic resin particle dispersion was obtained. The amount of the solid content in the styrene acrylic resin particle dispersion was adjusted to 20 mass % by adding ion exchanged water thereto.

### Preparation of Coloring Agent Particle Dispersion

35 parts of a cyan pigment (C.I. Pigment Blue 15:3, manufactured by Dainichiseika Color & Chemicals Mfg. Co., Ltd.)
2 parts of an anionic surfactant (NEOGEN R, manufactured by DKS CO. Ltd.)
250 parts of ion exchanged water

The above materials were mixed, dissolved, and dispersed for approximately one hour using a high-pressure impact type dispersing machine ULTIMIZER (HJP30006 manufactured by Sugino Machine Limited) to obtain a coloring agent particle dispersion. The volume average particle size D₅₀ᵥ of the particle in this coloring agent particle dispersion was 150 nm. After that, the concentration of the solid content was adjusted to 20 mass % by adding ion exchanged water thereto.

### Preparation of Release Agent Particle Dispersion

200 parts of paraffin wax (HNP-9, manufactured by Nippon Seiro Co., Ltd.)
Anionic surfactant (NEOGEN RK, manufactured by DKS CO. Ltd.): 10.0 parts
Ion exchanged water: 20.0 parts

The above materials were mixed together, a release agent was dissolved at an internal liquid temperature of 120° C. with a pressure discharge type homogenizer (GAULIN homogenizer manufactured by Gaulin Co., Ltd.), then dispersed at a dispersion pressure of 5 MPa for 120 min and subsequently at 40 MPa for 360 min, and cooled, thereby obtaining a dispersion. Ion exchanged water was added thereto to adjust the amount of the solid content to 20 mass %, and this dispersion was regarded as a release agent particle dispersion.

### Production of Toner Particle

Styrene acrylic resin particle dispersion: 375 parts
Coloring agent particle dispersion: 75 parts
Release agent particle dispersion: 15 parts
Ion exchanged water: 750 parts
Anionic surfactant (Dowfax2A1 manufactured by The Dow Chemical Co.): 3.2 parts

The above-described materials were put into a 3-liter reaction vessel equipped with a thermometer, a pH meter, and a stirrer as materials for forming a core portion, the pH was adjusted to 3.0 by adding 1.0% nitric acid thereto at a temperature of 25° C., 100 parts of a magnesium chloride aqueous solution having a concentration of 2.0 mass % was added thereto as an aggregating agent while the materials were dispersed with a homogenizer (ULTRA-TURRAX T50 manufactured by IKA) at 5,000 rpm, and the materials were dispersed for six minutes.

After that, a mixed liquid was heated up to 53° C. while the rotation speed was appropriately adjusted so that the mixed liquid was stirred using a stirring blade in a water bath for heating. The volume average particle size of the formed aggregated particle was appropriately confirmed with Coulter Multisizer III, the temperature was held when the volume average particle size reached 5.0 μm, and the pH was adjusted to 9.0 using a 5% sodium hydroxide aqueous solution. After that, the aggregated particle was heated up to 90° C. and held at 90° C. for one hour, thereby fusing the aggregated particle.

After that, the pH at 90° C. was adjusted to 5.0 by adding hydrochloric acid thereto, and the mixed liquid was further stirred for 30 minutes. Furthermore, a 0.9 mol/L-Na₂CO₃ aqueous solution was injected thereinto, the pH was adjusted to 5.5, and the mixed liquid was held for 30 minutes. After that, the mixed liquid was cooled to 25° C., filtered, separated into solid and liquid, and then washed with ion exchanged water. After the end of the washing, the mixed liquid was dried using a vacuum drier, thereby obtaining a toner particle 10 having a weight average particle size of 7.3 μm.

### Production Example of Toner 1

The strontium titanate fine particle A1 (0.6 parts), a silica fine particle B1 (0.8 parts), and the hydrotalcite particle C1 (0.2 parts) were externally added to and mixed with the toner particle 1 (100.0 parts) with FM10C (manufactured by Nippon Coke & Engineering Co., Ltd.). Regarding the external addition conditions, an A0 blade was used as a lower blade, the interval of a deflector with the wall was set to 20 mm, the amount of the toner particle charged was set to 2.0 kg, the rotation speed was set to 66.6 s⁻¹, the external addition time was set to 10 minutes, the temperature of cooling water was set to 20° C., and the flow rate thereof was set to 10 L/min.

After that, the particle was sieved with a mesh having an opening size of 200 μm, thereby obtaining a toner 1.

### Production Examples of Toner 2 to Toner 47

Toner 2 to toner 47 were obtained in the same manner as in the production example of the toner 1 except that the combination of the toner particle and the external additive was changed as shown in Table 5.

### Examples 1 to 42 and Comparative Examples 1 to 5

The following actual machine evaluations were performed using the toners 1 to 47. The evaluation results are shown in Table 6.

At the time of the evaluations, the process speed of HP LaserJet Enterprise M609dn was modified to 410 mm/sec and used.

In addition, as evaluation paper, Vitality (manufactured by Xerox Corporation, basis weight of 75 g/m², letter size) was used.

### High-Temperature and High-Humidity Environment HH Ghost Evaluation

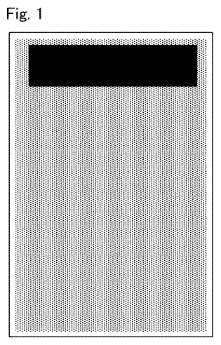

After an image forming testing machine and a cartridge filled with an evaluation toner were left to stand for one or more days in a high-temperature and high-humidity environment of 32.5° C./80% RH, an image of FIG. 1 was output with the above-described image forming testing machine. The ghost characteristics can be strictly evaluated from the image of FIG. 1. Specifically, when a ghost is generated, the density of a halftone portion is disturbed after a black band at the upper end is output. The ghost was evaluated depending on whether or not disturbance can be visually confirmed.

### Evaluation Criteria

A: No ghost trace is seen.
B: A shade corresponding to the black band is darkly seen in an upper third region of the image.
C: A shade corresponding to the black band is darkly seen in an upper half region of the image.
D: A shade corresponding to the black band is darkly seen in the entire region of the image.
E: A shade corresponding to the black band is clearly seen.

### Low-Temperature and Low-Humidity Environment LL Ghost Evaluation

After the above-described image forming testing machine and a cartridge filled with an evaluation toner were left to stand for one or more days in a low-temperature and low-humidity environment of 10° C./10% RH, 10000 prints of a test chart with a printing ratio of 1% were printed with the above-described image forming testing machine. After the printing of the 10000 prints, the image of FIG. 1 was output. The ghost characteristics can be strictly evaluated from the image of FIG. 1. Specifically, when a ghost is generated, the density of a halftone portion is disturbed after a black band at the upper end is output. The ghost was evaluated depending on whether or not disturbance can be visually confirmed.

### Evaluation Criteria

A: No ghost trace is seen.
B: A shade corresponding to the black band is thinly seen in an upper third region of the image.
C: A shade corresponding to the black band is thinly seen in an upper half region of the image.
D: A shade corresponding to the black band is thinly seen in the entire region of the image.
E: A shade corresponding to the black band is clearly seen.

### Evaluation of Contamination of Charging Toller (C Roller)

After the above-described image forming testing machine and a cartridge filled with an evaluation toner were left to stand for one or more days in a low-temperature and low-humidity environment of 10° C./10% RH, 10000 prints of a test chart with a printing ratio of 10% were printed with the above-described image forming testing machine. After the printing of the 10000 prints, three halftone images with a printing rate of 23% were output. In the present evaluation, in a case where a charging roller is contaminated, the charging ability of a contaminated portion decreases, a black vertical streak is thus generated in a case where a halftone image has been output. From the three obtained halftone images, the number of vertical streaks generated was counted, and the contamination of the charging roller was determined by the following criteria.

### Evaluation Criteria

A: No streaks are seen.
B: The width of a streak is less than 0.5 mm, and the number of streaks is from one to three.
C: The width of a streak is less than 0.5 mm, and the number of streaks is from four to six.
D: The width of a streak is less than 0.5 mm, and the number of streaks is from seven to nine.
E: The number of streaks having a streak width of less than 0.5 mm is 10 or more. Alternatively, a 0.5 mm or larger streak has been generated.

### Evaluation of Contamination of Photoreceptor

After the above-described image forming testing machine and a cartridge filled with an evaluation toner were left to stand for one or more days in a high-temperature and high-humidity environment of 32.5° C./80% RH, 10000 prints of a test chart with a printing ratio of 15% were printed with the above-described image forming testing machine. After the printing of the 10000 prints, a full-surface solid black image for which the amount of the toner applied per unit area was set to 1.0 mg/cm² was output, and the surface of a photoreceptor and the full-surface solid black image were visually confirmed. The contamination of the photoreceptor was determined by the following criteria.

### Evaluation Criteria

A: No toner fusion is seen on the photoreceptor.
B: Toner fusion is slightly seen on the photoreceptor but does not appear on the image.
C: A white dot missing image is shown on the solid black image.
D: A shooting star-like missing image is seen from a white dot on the solid black image.

### Evaluation of Charge Build-Up Properties in High-Temperature and High-Humidity Environment HH

After the above-described image forming testing machine and a cartridge filled with an evaluation toner were left to stand for one or more days in a high-temperature and high-humidity environment of 32.5° C./80% RH, 1000 prints of a test chart with a printing ratio of 1% were printed with the above-described image forming testing machine. After that, the image forming testing machine and the cartridge were left to stand for 72 hours in the same environment, and 100 prints were printed.

After the printing of the 1000 prints and after the printing of the 100 prints after the standing, the charge amount (μC/g) of the toner on a developing carrier in the toner cartridge was measured using a blow-off powder charge amount measuring instrument TB-200 (manufactured by Toshiba Chemical Corporation), and the charge build-up properties in a high-temperature and high-humidity environment was evaluated.

The larger the ratio of the charge amount after the printing of the 100 prints after the standing to the charge amount after the printing of the 1000 prints, the better the charge build-up properties of the toner are. The evaluation criteria of the charge build-up properties were determined as described below, and the charge build-up properties were evaluated.

The charge build-up properties were evaluated by the following criteria based on a numerical value of (charge amount after printing of 100 prints after standing)/(charge amount after printing of 1000 prints)×100.

### Evaluation Criteria

A: 95% or more
B: At least 90% and less than 95%
C: At least 85% and less than 90%
D: At least 80% and less than 85%
E: Less than 80%

### Evaluation of Charge Stability in Low-Temperature and Low-Humidity Environment LL

After the above-described image forming testing machine and a cartridge filled with an evaluation toner were left to stand for one or more days in a low-temperature and low-humidity environment of 10° C./10% RH, 10000 prints of a test chart with a printing ratio of 1% were printed with the above-described image forming testing machine.

After the printing of 5000 prints and after the printing of the 10000 prints, the charge amount (μC/g) of the toner on the developing carrier in the toner cartridge was measured using the blow-off powder charge amount measuring instrument TB-200 (manufactured by Toshiba Chemical Corporation), and the charge stability in a low-temperature and low-humidity environment was evaluated.

The larger the ratio of the charge amount after the printing of the 5000 prints to the charge amount after the printing of 10000 prints, the better the charge stability of the toner is. The evaluation criteria of the charge stability were determined as described below, and the charge stability was evaluated. The charge stability was evaluated by the following criteria based on a numerical value of (charge amount after printing of 5000 prints)/(charge amount after printing of 10000 prints)×100.

### Evaluation Criteria

A: 96% or more
B: At least 91% and less than 96%
C: At least 88% and less than 91%
D: At least 85% and less than 88%
E: Less than 85%

### Environmental Stability Evaluation

In each of after the printing of the 1000 prints in the evaluation of the charge build-up properties in a high-temperature and high-humidity environment and after the printing of the 1000 prints in the evaluation of the charge stability in a low-temperature and low-humidity environment, the charge amount (μC/g) of the toner on the developing carrier in the toner cartridge was measured using the blow-off powder charge amount measuring instrument TB-200 (manufactured by Toshiba Chemical Corporation), and the environmental stability was evaluated. The larger the ratio of the charge amount in the high-temperature and high-humidity environment to the charge amount in the low-temperature and low-humidity environment, the better the environmental stability of the toner is. The evaluation criteria of the environmental stability were determined as described below, and the environmental stability was evaluated. The environmental stability was evaluated by the following criteria based on a numerical value of (charge amount after printing of 1000 prints in high-temperature and high-humidity environment)/(charge amount after printing of 1000 prints in low-temperature and low-humidity environment)×100.

### Evaluation Criteria

A: 80% or more
B: At least 75% and less than 80%
C: At least 70% and less than 75%
D: Less than 70%

### Evaluation of Low-Temperature Fixability

In the evaluation of the low-temperature fixability, an external fixing device obtained by removing a fixing device of an evaluation machine, enabling the temperature of the fixing device to be arbitrarily set, and modifying the fixing device so that the process speed reached 410 mm/sec was used.

A solid black non-fixed image for which the amount of the toner applied per unit area was set to 0.5 mg/cm² was passed through the fixing device for which the temperature was adjusted to a set temperature using the above device in a normal temperature and normal humidity environment (temperature: 25° C., humidity: 50% RH). An obtained fixed image was reciprocally rubbed with lens-cleaning paper to which a load of 4.9 kPa (50 g/cm²) was applied five times, and a temperature at which the density reduction rate before and after a rubbing test reached 10% or less was regarded as a fixing temperature. The image density was measured on a Macbeth densitometer (manufactured by MacBeth & Co.), which is a reflection densitometer, using an SPI filter.

### Evaluation Criteria

A: The fixing temperature is lower than 200° C.
B: The fixing temperature is at least 200° C. and lower than 210° C.
C: The fixing temperature is at least 210° C. and lower than 220° C.
D: The fixing temperature is 220° C. or higher

### Evaluation of Scratch Resistance

In the evaluation of the scratch resistance, an external fixing device obtained by removing a fixing device of the evaluation machine, enabling the temperature of the fixing device to be arbitrarily set, and modifying the fixing device so that the process speed reached 450 mm/sec was used. Fixing was performed at the fixing temperature of each toner obtained by the above-described evaluation of the low-temperature fixability.

After a solid black non-fixed image for which the amount of the toner applied was set to 0.50 mg/cm² was obtained, the external fixing device was set to the fixing temperature of each toner, and fixing was performed under a normal temperature and normal humidity environment (temperature: 25° C., humidity: 50% RH). An obtained fixed image was reciprocally rubbed with paper obtained by cutting off a part of white evaluation paper (rubbing paper) under the application of a load of 4.9 kPa (50 g/cm²)¹⁰ times. The reflection densities were measured using a reflectometer (reflectometer model TC-6DS manufactured by Tokyo Denshoku Co., Ltd.) from the rubber rubbing paper and the white evaluation paper that was a remainder after the rubbing paper had been cut off, and the scratch resistance of the fixed image was evaluated by a difference in reflection density.

### Evaluation Criteria

A: The difference in reflection density is less than 1.0
B: The difference in reflection density is at least 1.0 and less than 2.0
C: The difference in reflection density is at least 2.0 and less than 3.0
D: The difference in reflection density is 3.0 or more

TABLE 1

| Strontium | Addition of Si | | Surface treatment | | Number | | Powder specific | | | | |
|---|---|---|---|---|---|---|---|---|---|---|---|
| titanate fine | Amount of | Protrusion | | Treatment | average | Amount | resistance | | | | |
| particle | Si added/ | portion at | Surface treatment | amount/ | particle | of C/ | value | | RA/ | | SP_{A} − |
| No. | mol % | surface | component | mass % | size/nm | mass % | RA/Ω · cm | Si/Sr | (Si/Sr) | Sb/Sa | SP_{D} |
| A1 | 5 | Present | Isobutyltrimethoxysilane | 14 | 45 | 3.4 | 1.2.E+10 | 0.32 | 3.8.E+10 | 2.02 | 3.10 |
| A2 | 7 | Present | Isobutyltrimethoxysilane | 20 | 48 | 4.5 | 6.0.E+10 | 0.50 | 1.2.E+11 | 1.98 | 3.10 |
| A3 | 3 | Present | Isobutyltrimethoxysilane | 12 | 40 | 2.7 | 2.9.E+09 | 0.26 | 1.1.E+10 | 2.04 | 3.10 |
| A4 | 3 | Present | Isobutyltrimethoxysilane | 6 | 80 | 1.2 | 1.9.E+09 | 0.26 | 7.3.E+09 | 2.06 | 3.10 |
| A5 | 7 | Present | Isobutyltrimethoxysilane | 15 | 25 | 3.6 | 4.0.E+09 | 0.38 | 1.1.E+10 | 1.95 | 3.10 |
| A6 | 3 | Present | Isobutyltrimethoxysilane | 5 | 100 | 1.0 | 1.5.E+09 | 0.26 | 5.8.E+09 | 2.08 | 3.10 |
| A7 | 7 | Present | Isobutyltrimethoxysilane | 17 | 15 | 3.9 | 9.7.E+09 | 0.38 | 2.6.E+10 | 1.94 | 3.10 |
| A8 | 8 | Present | Isobutyltrimethoxysilane | 25 | 50 | 5.2 | 9.7.E+11 | 0.59 | 1.6.E+12 | 2.00 | 3.10 |
| A9 | 2 | Present | Isobutyltrimethoxysilane | 5 | 38 | 1.0 | 1.2.E+08 | 0.20 | 6.0.E+08 | 2.01 | 3.10 |
| A10 | 2 | Present | Propyltrimethoxysilane | 6 | 38 | 0.9 | 1.2.E+08 | 0.20 | 6.0.E+08 | 2.01 | 3.96 |
| A11 | 2 | Present | Octyltriethoxysilane | 5 | 39 | 1.6 | 1.5.E+08 | 0.22 | 6.8.E+08 | 2.01 | 3.12 |
| A12 | 8 | Present | Octyltriethoxysilane | 25 | 32 | 8.3 | 1.3.E+12 | 0.59 | 2.2.E+12 | 2.02 | 3.12 |
| A13 | 2 | Present | Octyltriethoxysilane | 2 | 75 | 0.6 | 9.5.E+07 | 0.21 | 4.5.E+08 | 2.04 | 3.12 |
| A14 | 2 | Present | Octyltriethoxysilane | 2 | 77 | 0.6 | 9.7.E+07 | 0.21 | 4.6.E+08 | 2.20 | 3.12 |
| A15 | 2 | Present | Octyltriethoxysilane | 2 | 73 | 0.6 | 9.5.E+07 | 0.22 | 4.3.E+08 | 1.85 | 3.12 |
| A16 | 2 | Present | Octyltriethoxysilane | 2 | 78 | 0.6 | 9.8.E+07 | 0.20 | 4.9.E+08 | 2.33 | 3.12 |
| A17 | 2 | Present | Octyltriethoxysilane | 2 | 73 | 0.6 | 9.4.E+07 | 0.23 | 4.1.E+08 | 1.78 | 3.12 |
| A18 | 0.1 | Absent | Octyltriethoxysilane | 30 | 29 | 8.9 | 1.2.E+12 | 0.37 | 3.2.E+12 | 2.04 | 3.12 |
| A19 | 0 | Absent | Isobutyltrimethoxysilane | 5 | 40 | 1.0 | 4.7.E+09 | 0.09 | 5.2.E+10 | 2.00 | 3.12 |
| A20 | 0 | Absent | Isobutyltrimethoxysilane | 15 | 45 | 3.5 | 1.7.E+11 | 0.18 | 9.4.E+11 | 1.98 | 3.12 |
| A21 | 0 | Absent | None | 0 | 35 | 0 | 3.2.E+06 | 0 | — | 2.01 | 3.12 |
| A22 | 0.1 | Absent | Isobutyltrimethoxysilane | 14 | 37 | 3.1 | 9.2.E+10 | 0.21 | 4.4.E+11 | 2.02 | 3.12 |

In Table 1, the amount of Si added indicates the amount of Si from a sodium silicate aqueous solution.

The amount of C indicates the amount of C (carbon amount) derived from the hydrophobic treatment agent for the strontium titanate fine particle A.

For example, the expression 1.2.E+10 indicates 1.2×10¹⁰.

TABLE 2

| | | BET | | | |
|---|---|---|---|---|---|
| | | specific | | Number of | |
| | | surface | | parts of | |
| | | area | | surface | Number |
| | Type | during no | Surface | treatment | average |
| | of | treatment/ | treatment | agent/ | particle |
| | silica | m²/g | agent | Parts | size/nm |
| Silica fine | Fumed | 200 | polydimethyl- | 20 | 20 |
| particle B 1 | silica | | siloxane | | |
| Silica fine | Fumed | 50 | polydimethyl- | 7 | 50 |
| particle B 2 | silica | | siloxane | | |
| Silica fine | Fumed | 300 | polydimethyl- | 30 | 7 |
| particle B 3 | silica | | siloxane | | |
| Silica fine | Fumed | 40 | polydimethyl- | 6 | 70 |
| particle B 4 | silica | | siloxane | | |

TABLE 3

| | Number average particle size/nm |
|---|---|
| Hydrotalcite particle C 1 | 220 |
| Hydrotalcite particle C 2 | 500 |
| Hydrotalcite particle C 3 | 60 |
| Hydrotalcite particle C 4 | 700 |
| Hydrotalcite particle C 5 | 30 |

TABLE 4

| | Monomer composition:charged (molar ratio) | | | | | Physical properties of resin | |
|---|---|---|---|---|---|---|---|
| | | | Alcohol | | | Acid | Weight average |
| | Acid | | BPA | | | value | molecular weight |
| | TPA | TMA | (PO2) | EG | Isosorbide | mgKOH/g | Mw |
| Polyester resin D1 | 43.00 | 1.30 | 30.00 | 18.00 | 2.00 | 3.9 | 12100 |
| Polyester resin D2 | 43.00 | 1.30 | 32.00 | 18.00 | — | 4.0 | 12100 |

Abbreviations in the tables are as follows.
TPA: Terephthalic acid
TMA: Trimellitic anhydride
BPA (PO2): Propylene oxide 2 mol adduct of bisphenol A
EG: Ethylene glycol

TABLE 5

| | | Strontium titanate fine | | Silica fine | | Hydrotalcite | | | Average |
|---|---|---|---|---|---|---|---|---|---|
| | | particle A | | particle B | | particle C | | | circularity |
| | | | Number of | | Number of | | Number of | | of |
| | Toner particle | NO. | parts added | NO. | parts added | NO. | parts added | MA/MC | toner |
| Toner 1 | Toner particle 1 | 1 | 0.6 | 1 | 0.8 | 1 | 0.2 | 3.0 | 0.970 |
| Toner 2 | Toner particle 1 | 2 | 0.6 | 1 | 0.8 | 1 | 0.2 | 3.0 | 0.970 |
| Toner 3 | Toner particle 1 | 3 | 0.6 | 1 | 0.8 | 1 | 0.2 | 3.0 | 0.970 |
| Toner 4 | Toner particle 1 | 3 | 1.5 | 1 | 0.8 | 1 | 0.3 | 5.0 | 0.970 |
| Toner 5 | Toner particle 1 | 3 | 0.1 | 1 | 0.8 | 1 | 0.05 | 2.0 | 0.970 |
| Toner 6 | Toner particle 1 | 3 | 2.0 | 1 | 0.8 | 1 | 0.4 | 5.0 | 0.970 |
| Toner 7 | Toner particle 1 | 3 | 0.05 | 1 | 0.8 | 1 | 0.05 | 1.0 | 0.970 |
| Toner 8 | Toner particle 1 | 4 | 0.6 | 1 | 0.8 | 1 | 0.2 | 3.0 | 0.970 |
| Toner 9 | Toner particle 1 | 5 | 0.6 | 1 | 0.8 | 1 | 0.2 | 3.0 | 0.970 |
| Toner 10 | Toner particle 1 | 6 | 0.6 | 1 | 0.8 | 1 | 0.2 | 3.0 | 0.970 |
| Toner 11 | Toner particle 1 | 7 | 0.6 | 1 | 0.8 | 1 | 0.2 | 3.0 | 0.970 |
| Toner 12 | Toner particle 1 | 4 | 0.6 | 2 | 1.2 | 1 | 0.2 | 3.0 | 0.970 |
| Toner 13 | Toner particle 1 | 4 | 0.6 | 3 | 0.5 | 1 | 0.2 | 3.0 | 0.970 |
| Toner 14 | Toner particle 1 | 4 | 0.6 | 4 | 1.3 | 1 | 0.2 | 3.0 | 0.970 |
| Toner 15 | Toner particle 1 | 4 | 0.6 | 1 | 0.8 | 2 | 0.2 | 3.0 | 0.970 |
| Toner 16 | Toner particle 1 | 4 | 0.6 | 1 | 0.8 | 3 | 0.2 | 3.0 | 0.970 |
| Toner 17 | Toner particle 1 | 4 | 0.6 | 1 | 0.8 | 4 | 0.2 | 3.0 | 0.970 |
| Toner 18 | Toner particle 1 | 4 | 0.6 | 1 | 0.8 | 5 | 0.2 | 3.0 | 0.970 |
| Toner 19 | Toner particle 1 | 4 | 0.8 | 1 | 0.8 | 1 | 0.04 | 20.0 | 0.970 |
| Toner 20 | Toner particle 1 | 4 | 0.3 | 1 | 0.8 | 1 | 1.0 | 0.30 | 0.970 |
| Toner 21 | Toner particle 1 | 8 | 0.6 | 1 | 0.8 | 1 | 0.2 | 3.0 | 0.970 |
| Toner 22 | Toner particle 1 | 9 | 0.6 | 1 | 0.8 | 1 | 0.2 | 3.0 | 0.970 |
| Toner 23 | Toner particle 1 | 10 | 0.6 | 1 | 0.8 | 1 | 0.2 | 3.0 | 0.970 |
| Toner 24 | Toner particle 1 | 11 | 0.6 | 1 | 0.8 | 1 | 0.2 | 3.0 | 0.970 |
| Toner 25 | Toner particle 2 | 11 | 0.6 | 1 | 0.8 | 1 | 0.2 | 3.0 | 0.968 |
| Toner 26 | Toner particle 3 | 11 | 0.6 | 1 | 0.8 | 1 | 0.2 | 3.0 | 0.966 |
| Toner 27 | Toner particle 4 | 11 | 0.6 | 1 | 0.8 | 1 | 0.2 | 3.0 | 0.970 |
| Toner 28 | Toner particle 5 | 11 | 0.6 | 1 | 0.8 | 1 | 0.2 | 3.0 | 0.974 |
| Toner 29 | Toner particle 5 | 11 | 1.5 | 1 | 0.8 | 1 | 0.1 | 21.4 | 0.974 |
| Toner 30 | Toner particle 5 | 11 | 0.2 | 1 | 0.8 | 1 | 0.8 | 0.25 | 0.974 |
| Toner 31 | Toner particle 5 | 12 | 2 | 1 | 0.8 | 1 | 0.8 | 0.25 | 0.974 |
| Toner 32 | Toner particle 5 | 13 | 1.5 | 1 | 0.8 | 1 | 0.1 | 21.4 | 0.974 |
| Toner 33 | Toner particle 5 | 14 | 1.5 | 1 | 0.8 | 1 | 0.1 | 21.4 | 0.974 |
| Toner 34 | Toner particle 5 | 15 | 1.5 | 1 | 0.8 | 1 | 0.1 | 21.4 | 0.974 |
| Toner 35 | Toner particle 6 | 15 | 1.5 | 1 | 0.8 | 1 | 0.1 | 21.4 | 0.969 |
| Toner 36 | Toner particle 7 | 15 | 1.5 | 1 | 0.8 | 1 | 0.1 | 21.4 | 0.970 |
| Toner 37 | Toner particle 8 | 15 | 1.5 | 1 | 0.8 | 1 | 0.1 | 21.4 | 0.973 |
| Toner 38 | Toner particle 9 | 15 | 1.5 | 1 | 0.8 | 1 | 0.1 | 21.4 | 0.973 |
| Toner 39 | Toner particle 5 | 16 | 1.5 | 1 | 0.8 | 1 | 0.1 | 21.4 | 0.974 |
| Toner 40 | Toner particle 5 | 17 | 1.5 | 1 | 0.8 | 1 | 0.1 | 21.4 | 0.974 |
| Toner 41 | Toner particle 5 | 18 | 0.2 | 1 | 0.8 | 1 | 0.8 | 0.25 | 0.974 |
| Toner 42 | Toner particle 10 | 18 | 0.2 | 1 | 0.8 | 1 | 0.8 | 0.25 | 0.955 |
| Toner 43 | Toner particle 10 | 19 | 0.6 | 1 | 0.8 | 1 | 0.2 | 3.0 | 0.955 |
| Toner 44 | Toner particle 10 | 20 | 0.6 | 1 | 0.8 | 1 | 0.2 | 3.0 | 0.955 |
| Toner 45 | Toner particle 10 | 21 | 0.6 | 1 | 0.8 | 1 | 0.2 | 3.0 | 0.955 |
| Toner 46 | Toner particle 10 | 22 | 0.6 | 1 | 0.8 | Absent | 0 | — | 0.955 |
| Toner 47 | Toner particle 10 | Absent | 0 | 1 | 0.8 | 1 | 0.2 | — | 0.955 |

In the table, MA/MC indicates the value M_{A}/M_{C} of the ratio.

TABLE 6

| | | | | | | | | | | | | Low- | | | |
|---|---|---|---|---|---|---|---|---|---|---|---|---|---|---|---|
| Example | | HH | LL | C roller | Photoreceptor | HH charge build- | | LL charge | | Environmental | | temperature | | Scratch | |
| No. | | ghost | ghost | contamination | contamination | up properties | | retention | | stability | | fixability | | resistance | |
| 1 | Toner 1 | A | A | A | A | 101% | A | 100% | A | 87% | A | 190° C. | A | 0.4 | A |
| 2 | Toner 2 | A | A | A | A | 100% | A | 98% | A | 85% | A | 190° C. | A | 0.4 | A |
| 3 | Toner 3 | A | A | A | A | 98% | A | 100% | A | 85% | A | 190° C. | A | 0.4 | A |
| 4 | Toner 4 | A | A | A | A | 96% | A | 100% | A | 85% | A | 195° C. | A | 0.4 | A |
| 5 | Toner 5 | A | A | A | A | 101% | A | 96% | A | 85% | A | 185° C. | A | 0.2 | A |
| 6 | Toner 6 | B | A | A | A | 94% | B | 99% | A | 85% | A | 195° C. | A | 0.4 | A |
| 7 | Toner 7 | A | B | A | A | 98% | A | 94% | B | 85% | A | 185° C. | A | 0.2 | A |
| 8 | Toner 8 | A | A | A | A | 96% | A | 98% | A | 85% | A | 190° C. | A | 0.4 | A |
| 9 | Toner 9 | A | A | A | A | 100% | A | 96% | A | 85% | A | 190° C. | A | 0.4 | A |
| 10 | Toner 10 | B | A | A | A | 94% | B | 98% | A | 86% | A | 190° C. | A | 0.4 | A |
| 11 | Toner 11 | A | B | A | A | 100% | A | 94% | B | 85% | A | 190° C. | A | 0.4 | A |
| 12 | Toner 12 | B | A | A | A | 94% | B | 98% | A | 86% | A | 190° C. | A | 0.4 | A |
| 13 | Toner 13 | A | A | A | A | 98% | A | 96% | A | 85% | A | 190° C. | A | 0.4 | A |
| 14 | Toner 14 | B | A | A | A | 92% | B | 98% | A | 75% | B | 190° C. | A | 0.4 | A |
| 15 | Toner 15 | B | A | A | A | 94% | B | 98% | A | 85% | A | 190° C. | A | 0.8 | A |
| 16 | Toner 16 | A | A | A | A | 96% | A | 96% | A | 85% | A | 190° C. | A | 0.2 | A |
| 17 | Toner 17 | B | A | B | B | 92% | B | 98% | A | 76% | B | 190° C. | A | 0.8 | A |
| 18 | Toner 18 | A | B | B | A | 96% | A | 94% | B | 75% | B | 190° C. | A | 0.2 | A |
| 19 | Toner 19 | B | A | A | A | 94% | R | 98% | A | 85% | A | 190° C. | A | 0.2 | A |
| 20 | Toner 20 | A | A | A | A | 96% | A | 98% | A | 85% | A | 190° C. | A | 1.2 | B |
| 21 | Toner 21 | A | B | B | A | 98% | A | 94% | B | 85% | A | 190° C. | A | 0.4 | A |
| 22 | Toner 22 | B | A | A | A | 92% | B | 100% | A | 80% | A | 190° C. | A | 0.4 | A |
| 23 | Toner 23 | B | A | A | A | 92% | B | 100% | A | 75% | B | 190° C. | A | 0.4 | A |
| 24 | Toner 24 | B | A | A | B | 92% | B | 100% | A | 84% | A | 190° C. | A | 0.4 | A |
| 25 | Toner 25 | B | A | B | B | 93% | B | 98% | A | 85% | A | 190° C. | A | 0.4 | A |
| 26 | Toner 26 | B | A | B | B | 92% | B | 98% | A | 77% | B | 190° C. | A | 0.4 | A |
| 27 | Toner 27 | B | A | B | B | 90% | B | 96% | A | 77% | B | 190° C. | A | 0.4 | A |
| 28 | Toner 28 | B | A | B | B | 90% | B | 96% | A | 72% | C | 190° C. | A | 0.4 | A |
| 29 | Toner 29 | C | A | B | B | 88% | C | 96% | A | 72% | C | 195° C. | A | 0.4 | A |
| 30 | Toner 30 | B | B | B | B | 92% | B | 91% | B | 72% | C | 190° C. | A | 1.2 | B |
| 31 | Toner 31 | B | C | B | B | 91% | B | 88% | C | 72% | C | 190° C. | A | 1.2 | B |
| 32 | Toner 32 | C | A | B | B | 85% | C | 97% | A | 73% | C | 195° C. | A | 0.4 | A |
| 33 | Toner 33 | C | A | B | B | 85% | C | 96% | A | 72% | C | 195° C. | A | 0.4 | A |
| 34 | Toner 34 | C | A | B | B | 85% | C | 96% | A | 72% | C | 195° C. | A | 0.4 | A |
| 35 | Toner 35 | C | A | B | B | 85% | C | 96% | A | 72% | C | 195° C. | A | 1.6 | B |
| 36 | Toner 36 | C | A | B | B | 85% | C | 96% | A | 72% | C | 195° C. | A | 1.4 | B |
| 37 | Toner 37 | C | A | B | B | 85% | C | 96% | A | 73% | C | 205° C. | B | 1.4 | B |
| 38 | Toner 38 | C | A | B | B | 85% | C | 96% | A | 72% | C | 215° C. | C | 2.0 | C |
| 39 | Toner 39 | C | A | C | C | 85% | C | 96% | A | 72% | C | 195° C. | A | 0.4 | A |
| 40 | Toner 40 | C | A | B | C | 85% | C | 96% | A | 72% | C | 195° C. | A | 0.4 | A |
| 41 | Toner 41 | C | C | C | B | 88% | C | 88% | C | 72% | C | 190° C. | A | 1.2 | B |
| 42 | Toner 42 | C | C | C | B | 85% | C | 88% | C | 70% | C | 215° C. | C | 2.2 | C |
| Comparative | Toner 43 | C | D | D | C | 85% | C | 85% | D | 72% | C | 215° C. | C | 2.2 | C |
| Example 1 | | | | | | | | | | | | | | | |
| Comparative | Toner 44 | C | E | D | D | 88% | C | 79% | E | 72% | C | 215° C. | C | 2.2 | C |
| Example 2 | | | | | | | | | | | | | | | |
| Comparative | Toner 45 | D | D | D | C | 80% | D | 85% | D | 66% | D | 215° C. | C | 2.2 | C |
| Example 3 | | | | | | | | | | | | | | | |
| Comparative | Toner 46 | E | C | B | B | 75% | E | 89% | C | 76% | B | 215° C. | C | 1.0 | B |
| Example 4 | | | | | | | | | | | | | | | |
| Comparative | Toner 47 | C | E | E | D | 85% | C | 70% | E | 60% | D | 215° C. | C | 2.2 | C |
| Example 5 | | | | | | | | | | | | | | | |

According to the present disclosure, it is possible to provide a toner that has charge build-up properties in a high-temperature and high-humidity environment and charge stability in a low-temperature and low-humidity environment and enables an excellent image quality to be obtained while the toner contains a hydrotalcite particle and a silica fine particle.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-123239, filed Jul. 30, 2024, and Japanese Patent Application No. 2025-111546, filed Jul. 1, 2025, which are hereby incorporated by reference herein in their entirety.

What is claimed is:

1. A toner comprising:
a toner particle containing a binder resin; and
an inorganic fine particle,
wherein the inorganic fine particle contains a strontium titanate fine particle A, a silica fine particle B, and a hydrotalcite particle C,
Si is present at a surface of the strontium titanate fine particle A, and
a value Si/Sr of a mass ratio of Si to Sr, which is detected in a fluorescent X-ray analysis of the strontium titanate fine particle A, satisfies the following formula (1);
$$0.2 \leq Si / Sr \leq 0.6 . \qquad ( 1 )$$

2. The toner according to claim 1, wherein a content M_{A} of the strontium titanate fine particle A is 0.1 to 1.5 parts by mass with respect to 100 parts by mass of the toner particle.

3. The toner according to claim 1, wherein the strontium titanate fine particle A has a number average particle size of 25 to 80 nm.

4. The toner according to claim 1, wherein the silica fine particle B has a number average particle size of 5 to 50 nm.

5. The toner according to claim 1, wherein the hydrotalcite particle C has a number average particle size of 60 to 500 nm.

6. The toner according to claim 1, wherein the strontium titanate fine particle A has a powder specific resistance value R_{A} of 1.0×10⁸ to 1.0×10¹² Ω·cm.

7. The toner according to claim 1, wherein when a content of the strontium titanate fine particle A with respect to 100 parts by mass of the toner particle is indicated by M_{A}, and a content of the hydrotalcite particle C with respect to 100 parts by mass of the toner particle is indicated by M_{C}, a value M_{A}/M_{C} of a ratio of M_{A} to M_{C} satisfies the following formula (2);
$$0.3 \leq {M}_{A} / {M}_{C} \leq 20. . \qquad ( 2 )$$

8. The toner according to claim 1, wherein the value Si/Sr of the mass ratio satisfies the following formula (3);
$$0.26 \leq Si / Sr \leq 0 \text{.50} . \qquad ( 3 )$$

9. The toner according to claim 1, wherein when a powder specific resistance value of the strontium titanate fine particle A is indicated by R_{A}, the R_{A} and the value Si/Sr of the mass ratio satisfy the following formula (4);
$$1.7 \times 1 {0}^{8} \leq {R}_{A} / ( Si / Sr ) \leq 3. \times 1 {0}^{12} . \qquad ( 4 )$$

10. The toner according to claim 1, wherein a Si-containing protrusion portion is present at the surface of the strontium titanate fine particle A.

11. The toner according to claim 10, wherein the protrusion portion is formed of a silica fine particle.

12. The toner according to claim 1, wherein a charge control resin having a structure represented by the following formula (5) as an ionic functional group is present at a surface of the toner particle; 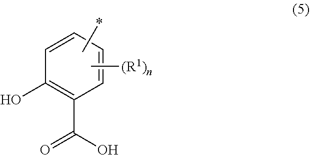
in the formula (5), R¹'s each independently represent an alkyl group having 1 to 18 carbon atoms or an alkoxy group having 1 to 18 carbon atoms, n represents an integer of 0 to 3, and * is a bonding site with a polymer.

13. The toner according to claim 1, wherein the toner particle has a polyester resin D at a surface.

14. The toner according to claim 13, wherein the polyester resin D has at least one selected from the group consisting of a monomer unit derived from an alcohol having an alicyclic structure and a monomer unit derived from carboxylic acid having an alicyclic structure.

15. The toner according to claim 1, wherein the toner particle contains ester wax.

16. The toner according to claim 15, wherein the ester wax is a polyfunctional ester wax having two or more ester groups.

17. The toner according to claim 15, wherein the ester wax is a bifunctional ester wax having two ester groups.
